(19) United States
(12) Patent Application Publication
(10) Pub. No.: US 2019/0358956 A1
(43) Pub. Date: Nov. 28, 2019

(54) PRINTING APPARATUS AND HEAD UNIT

(71) Applicant: SEIKO EPSON CORPORATION, Tokyo (JP)

(72) Inventors: Kinya OZAWA, Shiojiri-shi, Nagano-Ken (JP); Seiichi TANIGUCHI, Asahi-mura, Nagano-Ken (JP); Hidenori USUDA, Matsumoto-shi, Nagano-Ken (JP); Yasumasa NAKAJIMA, Shiojiri-shi, Nagano-Ken (JP)

(21) Appl. No.: 16/467,452

(22) PCT Filed: Nov. 30, 2017
(86) PCT No.: PCT/JP2017/043195

§ 371 Date: Jun. 6, 2019

(30) Foreign Application Priority Data
Dec. 9, 2016 (JP) 2016-239652

(51) Int. Cl. B41J 2/165; B41J 2/045

(52) U.S. Cl. CPC B41J 2/1652; B41J 2/04581; B41J 2002/16555; B41J 2202/20; B41J 2/16552

(57) ABSTRACT

An object of the invention is to be capable of reducing occurrence of printing failure due to a mist of a reaction liquid.

A printing apparatus includes: an ink discharge nozzle row 14b for discharging an ink; reaction liquid discharge nozzle rows 14a and 14c for discharging a reaction liquid having properties of aggregating the ink; and a plasma actuator 20 that generates an airflow with respect to a platen gap.

### TECHNICAL FIELD

The present invention relates to a printing apparatus and a head unit.

### BACKGROUND ART

In the related art, a printing method using an ink and a reaction liquid containing a substance for aggregating the ink is known. With the printing method, a high-quality printing result can be obtained without using a printing medium dedicated to an ink jet method. As the reaction liquid, a reaction liquid containing a polyvalent metal salt, such as a magnesium salt, a reaction liquid containing a cationic polymer, such as polyallylamine, as a substance for aggregating the ink, or the like, is known (refer to, for example, PTL 1).

In addition, in the related art, it is known that mist stagnates between platen gaps and adheres to a head and printing failure occurs. In particular, in a case of the above-described printing method, when the mist of the reaction liquid adheres to a nozzle of the ink, the ink is aggregated on an opening surface of the nozzle, and the printing failure is likely to occur.

As a measure against the mist, a technique is disclosed in which an airflow is generated between platen gaps to prevent mist from adhering to a head (refer to, for example, PTL 2). In addition, a technique is disclosed in which an airflow is aspirated below a platen to prevent mist from adhering to a head (refer to, for example, PTL 3).

### CITATION LIST

### Patent Literature

PTL 1: Japanese Unexamined Patent Application Publication No. 2005-225115

PTL 2: Japanese Unexamined Patent Application Publication No. 2010-195008

PTL 3: Japanese Unexamined Patent Application Publication No. 2007-38437

### SUMMARY OF INVENTION

### Technical Problem

However, in the related art described both in PTL 2 and PTL 3 in which the mist is prevented from adhering to the nozzle or the head, a large-scale airflow generating apparatus is required, and there is a problem that the size of a printing apparatus itself becomes large.

The present invention has been made in view of the above-described circumstances, and an object thereof is to be capable of reducing occurrence of printing failure due to the mist of a reaction liquid.

### Solution to Problem

In order to solve the above-described problem, an ink discharge nozzle row for discharging an ink; a reaction liquid discharge nozzle row for discharging a reaction liquid having properties of aggregating the ink; and a plasma actuator that generates an airflow with respect to a platen gap, are provided.

According to the present invention, since the airflow is generated by the plasma actuator with respect to the platen gap, the mist of the reaction liquid becomes unlikely to adhere to the ink discharge nozzle row, and it is possible to reduce occurrence of printing failure due to the mist of the reaction liquid. Further, by providing the plasma actuator, it is unnecessary to provide a large-scale airflow generating apparatus additionally, and equipment cost can be reduced.

In addition, in the present invention, the plasma actuator is disposed between the ink discharge nozzle row and the reaction liquid discharge nozzle row.

According to the present invention, since the plasma actuator is disposed between the ink discharge nozzle row and the reaction liquid discharge nozzle row, it is possible to generate the airflow between the ink discharge nozzle row and the reaction liquid discharge nozzle row by the plasma actuator, the mist of the reaction liquid becomes unlikely to adhere to the ink discharge nozzle row, and it is possible to reduce the occurrence of the printing failure due to the mist of the reaction liquid.

In addition, in the present invention, an ink jet head that is mounted on a carriage that reciprocates in a direction intersecting with a transport direction of a printing medium and has the ink discharge nozzle row, is further provided.

According to the present invention, in the ink jet head that is mounted on the carriage that reciprocates in the direction intersecting with the transport direction of the printing medium, since the airflow is generated by the plasma actuator with respect to the platen gap, the mist of the reaction liquid becomes unlikely to adhere to the ink discharge nozzle row, and it is possible to reduce the occurrence of the printing failure due to the mist of the reaction liquid.

In addition, in the present invention, the plasma actuator is disposed side by side with the ink discharge nozzle row in a moving direction of the ink jet head.

According to the present invention, since the plasma actuator is disposed side by side with the ink discharge nozzle row in the moving direction of the ink jet head, the mist of the reaction liquid becomes unlikely to adhere to the ink discharge nozzle row disposed in the moving direction of the ink jet head, and it is possible to reduce the occurrence of the printing failure due to the mist of the reaction liquid.

Further, the present invention includes a plurality of the plasma actuators that are disposed to interpose the ink discharge nozzle row therebetween.

In addition, according to the present invention, since the plurality of plasma actuators that are disposed to interpose the ink discharge nozzle row therebetween are provided, the mist of the reaction liquid becomes unlikely to adhere to the ink discharge nozzle row regardless of the moving direction of the ink jet head, and it is possible to reduce the occurrence of the printing failure due to the mist of the reaction liquid.

In addition, in the present invention, the plasma actuator generates the airflow in a discharge direction in which the ink discharge nozzle row discharges the ink.

According to the present invention, since the plasma actuator generates the airflow in the discharge direction in which the ink discharge nozzle row discharges the ink, it is possible to form an air curtain between the ink discharge nozzle row and the reaction liquid discharge nozzle row, the mist of the reaction liquid becomes unlikely to adhere to the ink discharge nozzle row, and it is possible to reduce the occurrence of the printing failure due to the mist of the reaction liquid.

In addition, in the present invention, an ink jet head having the ink discharge nozzle row that extends in a direction intersecting with a transport direction of a printing medium, is further provided.

According to the present invention, in the ink jet head having the ink discharge nozzle row that extends in the direction intersecting with the transport direction of the printing medium, since the airflow is generated by the plasma actuator with respect to the platen gap, the mist of the reaction liquid becomes unlikely to adhere to the ink discharge nozzle row, and it is possible to reduce the occurrence of the printing failure due to the mist of the reaction liquid.

In addition, in the present invention, the plasma actuator is disposed side by side with the ink discharge nozzle row in the transport direction of the printing medium.

According to the present invention, since the plasma actuator is disposed side by side with the ink discharge nozzle row in the transport direction of the printing medium, the mist of the reaction liquid becomes unlikely to adhere to the ink discharge nozzle row disposed in the transport direction of the printing medium, and it is possible to reduce the occurrence of the printing failure due to the mist of the reaction liquid.

In addition, in the present invention, the plasma actuator generates the airflow in a discharge direction in which the ink discharge nozzle row discharges the ink.

According to the present invention, since the plasma actuator generates the airflow in the discharge direction in which the ink discharge nozzle row discharges the ink, the air curtain is formed between the ink discharge nozzle row and the reaction liquid discharge nozzle row, the mist of the reaction liquid becomes unlikely to adhere to the ink discharge nozzle row, and it is possible to reduce the occurrence of the printing failure due to the mist of the reaction liquid.

In addition, in the present invention, a rotary drum for transporting the printing medium is further provided, and the plasma actuator generates the airflow in a direction opposite to a rotational direction in which the drum rotates.

According to the present invention, in a configuration in which the rotary drum that transports the printing medium is provided, since the plasma actuator generates the airflow in the direction opposite to the rotational direction in which the drum rotates, the mist of the reaction liquid becomes unlikely to adhere to the ink discharge nozzle row, and it is possible to reduce the occurrence of the printing failure due to the mist of the reaction liquid.

In addition, in the present invention, the ink discharge nozzle row includes a first ink discharge nozzle row for discharging a background image printing ink for printing a background image and a second ink discharge nozzle row for discharging a main image printing ink for printing a main image, the reaction liquid discharge nozzle row includes a first reaction liquid discharge nozzle row for discharging a reaction liquid having properties of aggregating the background image printing ink and a second reaction liquid discharge nozzle row for discharging the reaction liquid having properties of aggregating the main image printing ink, and the plasma actuator is disposed between the first ink discharge nozzle row and the first reaction liquid discharge nozzle row and between the second ink discharge nozzle row and the second reaction liquid discharge nozzle row.

According to the present invention, since the plasma actuator is disposed between the first ink discharge nozzle row and the first reaction liquid discharge nozzle row and between the second ink discharge nozzle row and the second reaction liquid discharge nozzle row, the mist of the reaction liquid that aggregates the background image printing ink becomes unlikely to adhere to the ink discharge nozzle row for discharging the background image printing ink, the mist of the reaction liquid that aggregates the main image printing ink becomes unlikely to adhere to the ink discharge nozzle row for discharging the main image printing ink, and it is possible to reduce the occurrence of the printing failure due to the mist of each reaction liquid.

In addition, in the present invention, the plasma actuator disposed between the first ink discharge nozzle row and the first reaction liquid discharge nozzle row generates the airflow having a larger air volume than that of the airflow generated by the plasma actuator disposed between the second ink discharge nozzle row and the second reaction liquid discharge nozzle row.

According to the present invention, since the plasma actuator disposed between the first ink discharge nozzle row and the first reaction liquid discharge nozzle row generates the airflow having a larger air volume than that of the airflow generated by the plasma actuator disposed between the second ink discharge nozzle row and the second reaction liquid discharge nozzle row, the mist of the reaction liquid that aggregates the background image printing ink becomes unlikely to adhere to the ink discharge nozzle row for discharging the background image printing ink and to adhere to the ink discharge nozzle row for discharging the main image printing ink, and it is possible to reduce the occurrence of the printing failure due to the mist of the reaction liquid that aggregates the background image printing ink.

In addition, in the present invention, a head unit having a driving voltage generation unit that generates a driving voltage for driving the plasma actuator, and the ink discharge nozzle row, is further provided.

According to the present invention, it is possible to generate a driving voltage to the plasma actuator driven with a high voltage by the driving voltage generation unit. Therefore, it is unnecessary to lay a high voltage wiring on a flexible cable, and problems, such as insulation, short-circuiting measures, noise countermeasures, and the like, do not occur.

In addition, in the present invention, a head unit having a driving voltage generation unit that generates a driving voltage for driving the plasma actuator, and the reaction liquid discharge nozzle row, is further provided.

According to the present invention, it is possible to generate a driving voltage to the plasma actuator driven with a high voltage by the driving voltage generation unit. Therefore, it is unnecessary to lay a high voltage wiring on a flexible cable, and problems, such as insulation, short-circuiting measures, noise countermeasures, and the like, do not occur.

In addition, in the present invention, a length of the plasma actuator is longer than a length of the reaction liquid discharge nozzle row.

According to the present invention, since the length of the plasma actuator is longer than the length of the reaction liquid discharge nozzle row, the mist of the reaction liquid becomes unlikely to adhere to the ink discharge nozzle row, and it is possible to reduce the occurrence of the printing failure due to the mist of the reaction liquid.

In addition, in the present invention, the length of the plasma actuator is longer than a length of the ink discharge nozzle row.

According to the present invention, since the length of the plasma actuator is longer than the length of the ink discharge nozzle row, the mist of the reaction liquid becomes unlikely to adhere to the ink discharge nozzle row, and it is possible to reduce the occurrence of the printing failure due to the mist of the reaction liquid.

In order to solve the above-described problem, an ink discharge nozzle row for discharging an ink; a reaction liquid discharge nozzle row for discharging a reaction liquid having properties of aggregating the ink; and a plasma actuator that generates an airflow with respect to a platen gap, are provided.

According to the present invention, since the airflow is generated by the plasma actuator with respect to the platen gap, the mist of the reaction liquid becomes unlikely to adhere to the ink discharge nozzle row, and it is possible to reduce the occurrence of printing failure due to the mist of the reaction liquid. Further, by providing the plasma actuator, it is unnecessary to provide a large-scale airflow generating apparatus additionally, and equipment cost can be reduced.

### BRIEF DESCRIPTION OF DRAWINGS

FIG. 1 is a view illustrating an outline of a printing apparatus according to a first embodiment.

FIG. 2 is a schematic view of a head unit of the printing apparatus.

FIG. 3 is a schematic view from a liquid discharge surface side of FIG. 2.

FIG. 4 is a sectional view illustrating a basic structure of a plasma actuator.

FIG. 5 is a view illustrating a modification example of disposition of the plasma actuators.

FIG. 6 is a view illustrating a modification example of disposition of the plasma actuators.

FIG. 7 is a block diagram illustrating a functional configuration of the printing apparatus.

FIG. 8 is a view illustrating an outline of a printing apparatus according to a second embodiment.

FIG. 9 is a schematic view from a liquid discharge surface side of FIG. 7.

FIG. 10 is a view illustrating an outline of the printing apparatus.

FIG. 11 is a schematic view from a liquid discharge surface side of FIG. 10.

FIG. 12 is a view illustrating an outline of a printing apparatus according to a third embodiment.

FIG. 13 is a view illustrating an outline of the printing apparatus.

### DESCRIPTION OF EMBODIMENTS

### First Embodiment

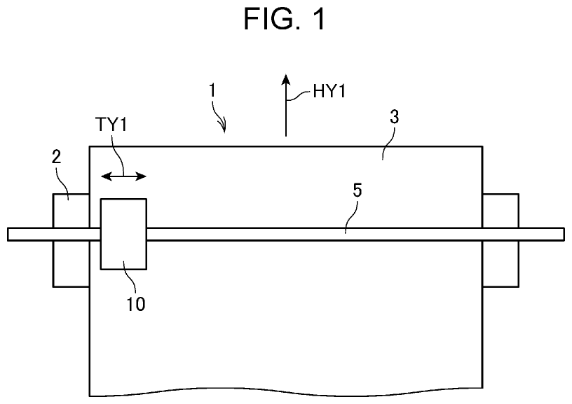

FIG. 1 is a schematic view of a printing apparatus 1 according to a first embodiment.

As illustrated in FIG. 1, the printing apparatus 1 is provided with a flat platen 2. A predetermined printing medium 3 is transported to an upper surface of the platen 2 in a transport direction HY1 by a paper feed mechanism (not illustrated). The platen 2 may be provided with an ink abandoning region during marginless printing.

Examples of the printing medium 3 include a roll paper sheet wound in a roll shape, a cut sheet cut to a predetermined length, and a continuous sheet to which a plurality of sheets are connected to each other. The printing media are a plain paper sheet, a paper sheet, such as a copying paper sheet or a thick paper sheet, and a sheet, such as a sheet made of synthetic resin, and the sheets which have been subjected to processing, such as coating or infiltration, can also be used. In addition, a form of the cut sheet, for example, in addition to a regular size cut paper sheet, such as a PPC paper sheet or a postcard, a form of a booklet in which a plurality of sheets, such as passbooks, are bound, or a form formed into a bag shape, such as an envelope, can be employed. Further, as a form of a continuous sheet, for example, a continuous paper sheet folded at a predetermined length can be employed, in which sprocket holes are formed at both ends in a width direction.

Above the platen 2, a guide shaft 5 that extends in a direction TY1 (intersecting direction) orthogonal to the transport direction HY1 of the printing medium 3 is provided. A carriage 10 is provided on the guide shaft 5 so as to freely reciprocate along the guide shaft 5 via a driving mechanism (not illustrated). In other words, the carriage 10 reciprocates along the guide shaft 5 in the direction TY1 orthogonal to the transport direction HY1.

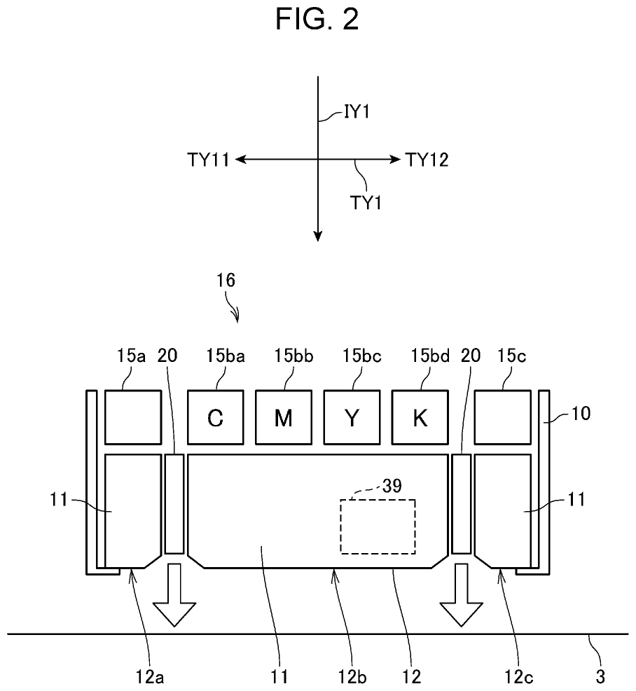

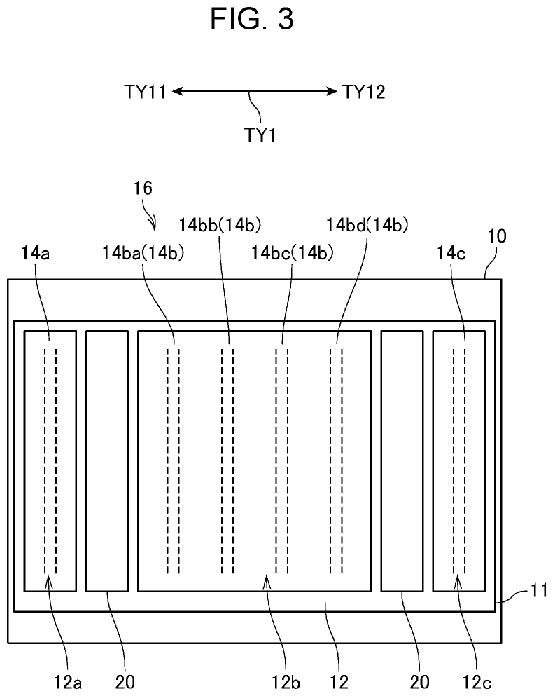

FIG. 2 is a perspective view illustrating a head unit 16 of the printing apparatus 1 according to the first embodiment. In addition, FIG. 3 is a schematic view from a liquid discharge surface 12 side of FIG. 2.

As illustrated in FIG. 2, a serial type ink jet head 11 is mounted on the carriage 10.

A surface opposing the platen 2 of the ink jet head 11 is the liquid discharge surface 12. The liquid discharge surface 12 has a reaction liquid discharge surface 12a, an ink discharge surface 12b, and a reaction liquid discharge surface 12c.

On the reaction liquid discharge surface 12a, a reaction liquid discharge nozzle row 14a which is opened to the reaction liquid discharge surface 12a and configured with a plurality of nozzle holes for discharging the reaction liquid having properties of aggregating the ink discharged from each of ink discharge nozzle rows 14ba to 14bd which will be described later onto the printing medium 3, is formed. In the present embodiment, the reaction liquid discharge nozzle row 14a is formed in two rows in parallel.

On the ink discharge surface 12b, the ink discharge nozzle row 14ba to the ink discharge nozzle row 14bd which are opened to the ink discharge surface 12b and configured with a plurality of nozzle holes for discharging the ink onto the printing medium 3, are formed. In the present embodiment, each of the ink discharge nozzle rows 14ba to 14bd is formed in two rows in parallel. Further, in the present embodiment, the ink discharge nozzle row 14ba discharges a cyan (C) ink onto the printing medium 3. In addition, the ink discharge nozzle row 14bb discharges a magenta (M) ink onto the printing medium 3. Further, the ink discharge nozzle row 14bc discharges a yellow (Y) ink onto the printing medium 3. In addition, the ink discharge nozzle row 14bd discharges a black (K) ink onto the printing medium 3.

In addition, in the following description, in a case of describing each of the ink discharge nozzle row 14ba to the ink discharge nozzle row 14bd as one ink discharge nozzle row without distinction, the ink discharge nozzle rows will be referred to as an ink discharge nozzle row 14b.

On the reaction liquid discharge surface 12c, a reaction liquid discharge nozzle row 14c which is opened to the reaction liquid discharge surface 12c and configured with a plurality of nozzle holes for discharging the reaction liquid having properties of aggregating the ink discharged from the ink discharge nozzle rows 14ba to 14bd onto the printing medium 3, is formed. In the present embodiment, the reaction liquid discharge nozzle row 14c is formed in two rows in parallel.

In addition, as the reaction liquid discharged from the reaction liquid discharge nozzle row 14a and the reaction liquid discharge nozzle row 14c, for example, a liquid using polyvalent metal salt, such as magnesium salt, a liquid containing a cationic polymer, such as polyallylamine, as an ink coagulant that reacts with a resin or a pigment component in the ink and aggregates the resin or the pigment component, or the like, is employed.

Here, a gap (space) between the liquid discharge surface 12 and the platen 2, or the gap (space) between the liquid discharge surface 12 and the printing medium 3 is collectively referred to as a platen gap.

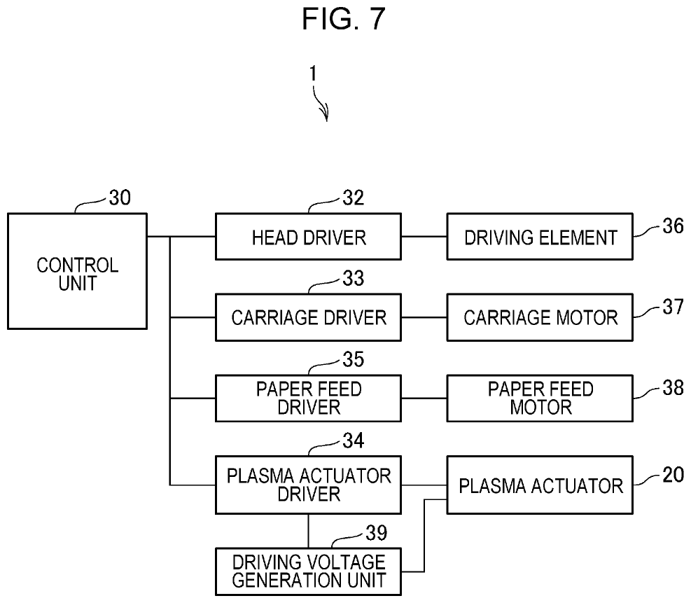

The ink jet head 11 includes a driving element 36 (FIG. 7), such as a piezoelectric element for discharging the reaction liquid from the reaction liquid discharge nozzle row 14a. In addition, a reaction liquid cartridge 15a for supplying a reaction liquid to be discharged from the reaction liquid discharge nozzle row 14a is mounted on the carriage 10. The reaction liquid cartridge 15a is a cartridge having a tank for storing the reaction liquid to be discharged from the reaction liquid discharge nozzle row 14a.

The ink jet head 11 includes the driving element 36 (FIG. 7), such as a piezoelectric element for discharging the ink from each of the ink discharge nozzle rows 14ba to 14bd. In addition, ink cartridges 15ba to 15bd for supplying the ink to the ink jet head 11 are mounted on the carriage 10. The ink cartridge 15ba supplies the cyan ink to the ink discharge nozzle row 14ba. In addition, the ink cartridge 15bb supplies the magenta ink to the ink discharge nozzle row 14bb. The ink cartridge 15bc supplies the yellow ink to the ink discharge nozzle row 14bc. In addition, the ink cartridge 15bd supplies the black ink to the ink discharge nozzle row 14bd.

The ink jet head 11 includes the driving element 36 (FIG. 7), such as a piezoelectric element for discharging the reaction liquid from the reaction liquid discharge nozzle row 14c. In addition, a reaction liquid cartridge 15c for supplying the reaction liquid to be discharged from the reaction liquid discharge nozzle row 14c is mounted on the carriage 10. The reaction liquid cartridge 15c is a cartridge having a tank for storing the reaction liquid to be discharged from the reaction liquid discharge nozzle row 14c.

In this manner, the head unit 16 is configured with the carriage 10, the ink jet head 11, the reaction liquid cartridge 15a, the ink cartridges 15ba to 15bd, and the reaction liquid cartridge 15c. In addition, in the present embodiment, the ink jet head 11 includes the reaction liquid discharge nozzle row 14a, the ink discharge nozzle rows 14ba to 14bd, and the reaction liquid discharge nozzle row 14c, but the head including the reaction liquid discharge nozzle row 14a and the head including the reaction liquid discharge nozzle row 14c may be configured separately from the ink jet head 11 including the ink discharge nozzle rows 14ba to 14bd. In addition, each of the reaction liquid cartridge 15a, the ink cartridges 15ba to 15bd, and the reaction liquid cartridge 15c may be installed at a place other than the head unit 16.

A plasma actuator 20 is disposed between the reaction liquid discharge surface 12a and the ink discharge surface 12b and between the reaction liquid discharge surface 12c and the ink discharge surface 12b. In other words, the two plasma actuators 20 are disposed to interpose the ink discharge surface 12b therebetween. In other words, the two plasma actuators 20 are disposed to interpose the ink discharge nozzle row 14b therebetween. Each of the plasma actuators 20 is formed longer than at least one of the length of the ink discharge nozzle row 14 or the length of the ink discharge nozzle row 14. By doing so, the mist generated from the reaction liquid discharge nozzle row 14 becomes unlikely to adhere to the ink discharge nozzle row 14, and it is possible to reduce the occurrence of the printing failure due to the mist of the reaction liquid. The support of each of the plasma actuators 20 may be any support, may be supported by being fitted to the ink jet head 11, or may be supported by the carriage 10.

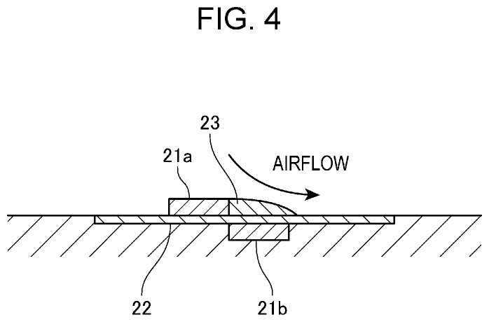

FIG. 4 is a sectional view illustrating a basic structure of the plasma actuator 20. As illustrated in FIG. 4, the plasma actuator 20 is configured with two thin film electrodes 21a and 21b and a dielectric layer 22 interposed between the electrodes 21a and 21b. By applying an AC voltage of several kV and a frequency of several kHz between the two electrodes 21a and 21b, a plasma discharge 23 is generated at a part interposed between the upper electrode 21a and the dielectric 22, and accordingly, an airflow that flows from the upper electrode 21a to the lower electrode 21b is generated. The plasma actuator 20 can simply control the generation, stop, or airflow velocity of the airflow by controlling the application of the AC voltage. This is a feature that is difficult to be realized with an airflow generating device, such as a fan. In addition, two thin film electrodes 21b may be prepared and disposed so as to interpose the electrode 21a. By doing so, when one side of the two electrodes 21b is selected, a direction in which the airflow is generated can be controlled in both forward and reverse directions.

Here, a printing operation of the printing apparatus 1 in the present embodiment will be described.

In the printing apparatus 1, when the ink is discharged onto the printing medium 3 from the ink discharge nozzle rows 14ba to 14bd and an image is printed on the printing medium 3, the reaction liquid is discharged from any of the reaction liquid discharge nozzle row 14a and the reaction liquid discharge nozzle row 14c. For example, when the carriage 10 moves in a direction TY11 and performs printing on the printing medium 3, the printing apparatus 1 discharges the reaction liquid from the reaction liquid discharge nozzle row 14a onto the printing medium 3, and discharges the ink from the ink discharge nozzle rows 14ba to 14bd onto the discharged reaction liquid. The ink discharged from the ink discharge nozzle row 14b is aggregated by the reaction liquid. In addition, for example, when the carriage 10 moves in a direction TY12 and performs printing on the printing medium 3, the printing apparatus 1 discharges the reaction liquid from the reaction liquid discharge nozzle row 14c onto the printing medium 3, and discharges the ink from the ink discharge nozzle rows 14ba to 14bd onto the discharged reaction liquid. The ink discharged from the ink discharge nozzle row 14b is aggregated by the reaction liquid.

In the printing method using such a reaction liquid, in a case where a water-soluble dye ink in which a water-soluble dye is dissolved in water or a mixed solution of water and an organic solvent is used as an ink, even when not a printing medium (for example, a printing medium dedicated to an ink jet method) dedicated to the water-soluble dye ink, but, for example, a plain paper sheet or a recycled paper sheet is used, it is possible to obtain a high-quality printing result.

However, in a case where the plasma actuator 20 is not provided, in the printing method using the reaction liquid, the mist of the reaction liquid is generated between the platen gaps, adheres to the ink discharge surface 12b, is thickened, and is solidified, and accordingly, there is a possibility that the printing failure occurs. In particular, when the ink jet head 11 moves, there is a possibility that the airflow is generated in the platen gap in the direction opposite to the moving direction due to the movement of the ink jet head 11. In this case, for example, when the ink jet head 11 moves in the direction TY11, there is a high probability that the mist of the reaction liquid discharged from the reaction liquid discharge nozzle row 14a flows in the direction opposite to the direction TY11 (direction TY12), adheres to the ink discharge nozzle row 14b, is thickened, and is solidified. The mist of the reaction liquid reacts with the resin or the pigment component in the ink and aggregates the resin or the pigment component, that is, is thickened and solidified. When this occurs in a nozzle opening portion, flying curve or nozzle clogging occurs.

Here, the plasma actuator 20 is disposed as illustrated in FIGS. 2 and 3. In other words, the plasma actuator 20 is disposed between the reaction liquid discharge nozzle row 14a and the ink discharge nozzle row 14b and between the reaction liquid discharge nozzle row 14c and the ink discharge nozzle row 14b. The two thin film electrodes 21a and 21b of the plasma actuator 20 and the dielectric layer 22 interposed between the electrodes 21a and 21b are disposed in the gap between the ink jet head 11 and the plasma actuator 20 in FIG. 2. The gap may be a space between the reaction liquid discharge nozzle rows 14a and 14c or a space between the reaction liquid discharge nozzle row 14a and the ink discharge nozzle row 14b, or the electrodes may be disposed both between the reaction liquid discharge nozzle rows 14a and 14c and between the reaction liquid discharge nozzle row 14a and the ink discharge nozzle row 14b. By disposing the plasma actuator 20 in this manner, it is possible to generate the airflow by the plasma actuator 20 between the reaction liquid discharge nozzle row 14a and the ink discharge nozzle row 14b and between the reaction liquid discharge nozzle row 14c and the ink discharge nozzle row 14b. Therefore, it is possible to suppress the adhesion of the mist of the reaction liquid discharged from the reaction liquid discharge nozzle row 14a to the ink discharge nozzle row 14b, and it is possible to suppress the adhesion of the mist of the reaction liquid discharged from the reaction liquid discharge nozzle row 14c to the ink discharge nozzle row 14b. Therefore, the printing apparatus 1 can reduce the occurrence of the printing failure due to the mist of the reaction liquid.

In addition, as illustrated in FIGS. 2 and 3, the plasma actuator 20 is disposed side by side with the ink discharge nozzle row 14b in the moving direction of the ink jet head 11. Here, the moving direction of the ink jet head 11 corresponds to the moving direction of the carriage 10, that is, the direction TY1 orthogonal to the transport direction HY1. By disposing the plasma actuator 20 and generating the airflow by the plasma actuator 20, it is possible to suppress the adhesion of the mist of the reaction liquid discharged from the reaction liquid discharge nozzle row 14a to the ink discharge nozzle row 14b disposed in the moving direction of the ink jet head 11, and it is possible to suppress the adhesion of the mist of the reaction liquid discharged from the reaction liquid discharge nozzle row 14c to the ink discharge nozzle row 14b disposed in the moving direction of the ink jet head 11. Therefore, in the printing apparatus 1, it is possible to reduce the occurrence of the printing failure due to the mist of the reaction liquid.

In addition, the two plasma actuators 20 are disposed to interpose the ink discharge surface 12b therebetween. In a case where the moving direction of the ink jet head 11 is the direction TY11, the reaction liquid is discharged from the reaction liquid discharge nozzle row 14a, and the reaction liquid is not discharged from the reaction liquid discharge nozzle row 14c. Therefore, the printing apparatus 1 drives the plasma actuator 20 disposed between the reaction liquid discharge nozzle row 14a and the ink discharge nozzle row 14b. On the contrary, in a case where the moving direction of the ink jet head 11 is the direction TY12, the reaction liquid is discharged from the reaction liquid discharge nozzle row 14c, and the reaction liquid is not discharged from the reaction liquid discharge nozzle row 14a. Therefore, the printing apparatus 1 drives the plasma actuator 20 disposed between the reaction liquid discharge nozzle row 14c and the ink discharge nozzle row 14b. It is needless to say that both the plasma actuators 20 may be driven regardless of the moving direction, or only one of the plasma actuators 20 that corresponds to the moving direction may be driven. By performing the control in this manner, it is possible to suppress the adhesion of the mist of the reaction liquid discharged from the reaction liquid discharge nozzle row 14a and the reaction liquid discharge nozzle row 14c to the ink discharge nozzle row 14b. Therefore, in the printing apparatus 1, it is possible to reduce the occurrence of the printing failure due to the mist of the reaction liquid.

Further, as illustrated in FIG. 3, the plasma actuator 20 generates the airflow in a discharge direction IY1 (in a case of FIG. 3, from the nozzle surface 12b toward a front side) in which the ink discharge nozzle row 14b discharges the ink. In this manner, since the plasma actuator 20 generates the airflow in the discharge direction IY1, an air curtain is formed between the reaction liquid discharge nozzle row 14a and the ink discharge nozzle row 14b and between the reaction liquid discharge nozzle row 14c and the ink discharge nozzle row 14b. Therefore, the mist of the reaction liquid becomes unlikely to adhere to the ink discharge nozzle row 14b, and it is possible to reduce the occurrence of the printing failure due to the mist of the reaction liquid. In addition, since the plasma actuator 20 generates the airflow in the discharge direction IY1 of the ink, it is possible to suppress disturbance of a landing position of the reaction liquid. Further, it becomes possible to make the mist of the reaction liquid land on the printing medium 3.

In addition, in the present embodiment, generation of the airflow in the discharge direction IY1 corresponds to generation of the airflow to the platen gap.

Next, a modification example of disposition of the plasma actuators 20 will be described.

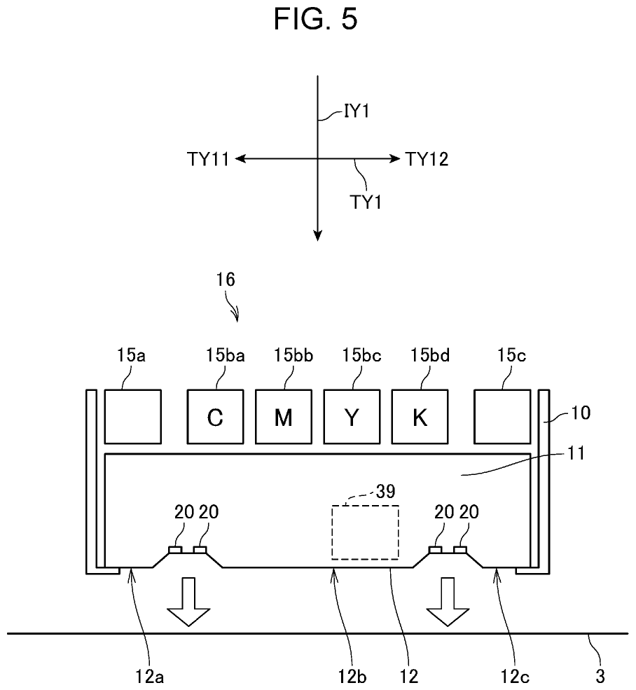

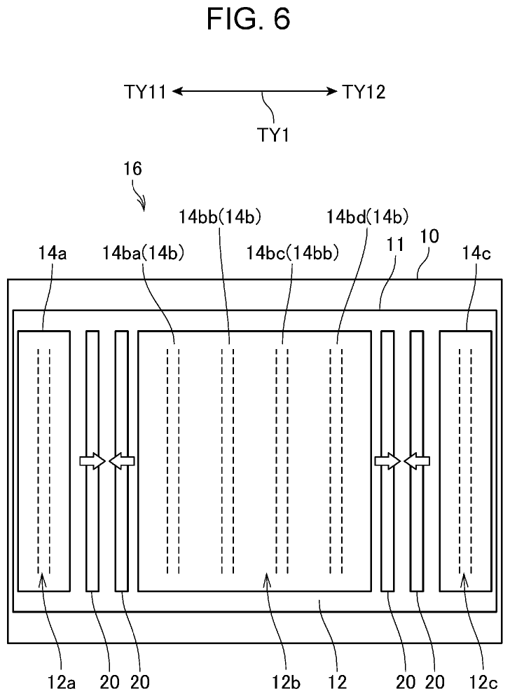

FIGS. 5 and 6 are views illustrating modification examples of the disposition of the plasma actuators 20. FIG. 5 is a schematic view of the head unit 16 of the printing apparatus 1. In addition, FIG. 6 is a schematic view when the head unit 16 is viewed from the liquid discharge surface 12 of FIG. 5.

Configurations similar to those in FIGS. 2 and 3 will be given the same reference numerals, and the detailed description thereof will be omitted.

As can be apparent by comparing to FIGS. 2 and 3, in the modification example, there is no gap between the ink jet head 11 and the plasma actuator 20. Therefore, it is not possible to dispose the electrodes as illustrated in FIGS. 2 and 3. Here, in the present modification example, the plasma actuators 20 are disposed two by two between the reaction liquid discharge nozzle row 14a and the ink discharge nozzle row 14b and between the reaction liquid discharge nozzle row 14c and the ink discharge nozzle row 14b such that the airflows are generated in directions facing each other.

By disposing each of the plasma actuators 20 in this manner, since the airflows facing each other collide with each other between the two plasma actuators 20, as illustrated in FIG. 5, it is possible to generate the airflow in the discharge direction IY1 in which the ink is discharged. In addition, in the two plasma actuators 20 disposed between the reaction liquid discharge nozzle row 14c and the ink discharge nozzle row 14b, the airflow is also similarly generated in the discharge direction IY1 in which the ink is discharged. Therefore, even in a case where the plasma actuator 20 is disposed as illustrated in FIGS. 5 and 6, the same effects as those described above can be obtained.

In addition, in the present embodiment, a case where the plasma actuator 20 generates the airflow in the discharge direction IY1 of the ink has been exemplified, but when it is possible to suppress the adhesion of the mist of the reaction liquid to the ink discharge nozzle row 14b, the direction in which the airflow is generated is not limited to the discharge direction IY1 of the ink.

For example, the plasma actuator 20 disposed between the reaction liquid discharge nozzle row 14a and the ink discharge nozzle row 14b may be configured to generate the airflow in the direction of the reaction liquid discharge nozzle row 14a. Accordingly, it is possible to suppress the adhesion of the mist of the reaction liquid discharged from the reaction liquid discharge nozzle row 14a to the ink discharge nozzle row 14b.

Further, for example, the plasma actuator 20 disposed between the reaction liquid discharge nozzle row 14c and the ink discharge nozzle row 14b may be configured to generate the airflow in the direction of the reaction liquid discharge nozzle row 14c. Accordingly, it is possible to suppress the adhesion of the mist of the reaction liquid discharged from the reaction liquid discharge nozzle row 14c to the ink discharge nozzle row 14b.

Further, the configurations may be combined with each other. Accordingly, it is possible to suppress the adhesion of the mist of the reaction liquid discharged from the reaction liquid discharge nozzle row 14a and the reaction liquid discharge nozzle row 14c to the ink discharge nozzle row 14b.

Next, a functional configuration of the present embodiment will be described.

FIG. 7 is a block diagram illustrating the functional configuration of the printing apparatus 1 according to the present embodiment.

As illustrated in FIG. 7, the printing apparatus 1 includes a control unit 30 for controlling each part, and various driver circuits for driving various motors and the like in accordance with the control of the control unit 30 or outputting a detection state of a detection circuit to the control unit 30. The various driver circuits include a head driver 32, a carriage driver 33, a plasma actuator driver 34, and a paper feed driver 35.

The control unit 30 centrally controls each part of the printing apparatus 1. The control unit 30 includes a CPU, an executable basic control program, a ROM that stores data or the like related to the basic control program in a nonvolatile manner, a RAM that temporarily stores programs executed by the CPU, predetermined data, and the like, other peripheral circuits, and the like.

The head driver 32 is connected to a driving element 36, such as a piezoelectric element for discharging the ink, respectively. The driving element 36 is driven under the control of the control unit 30 and discharges a necessary amount of ink from the nozzle hole.

The carriage driver 33 is connected to the carriage motor 37, outputs a driving signal to the carriage motor 37, and operates the carriage motor 37 within a range instructed by the control unit 30.

The plasma actuator driver 34 is connected to the plasma actuator 20, outputs the driving signal to the plasma actuator 20, and drives the plasma actuator 20 by the control unit 30.

The paper feed driver 35 is connected to a paper feed motor 38, outputs the driving signal to the paper feed motor 38, and operates the paper feed motor 38 only by an amount instructed by the control unit 30. In accordance with the operation of the paper feed motor 38, the printing medium 3 is transported only by a predetermined amount in the transport direction HY1.

In order to drive the plasma actuator 20, a high voltage is required. The printing apparatus 1 includes a driving voltage generation unit 39 for generating a driving voltage for driving the plasma actuator 20. The driving voltage generation unit 39 is connected to the plasma actuator 20 and the plasma actuator driver 34. The driving voltage generation unit 39 is supported by the carriage 10, for example, and is mounted on the head unit 16.

A flexible cable for transmitting a head driving signal is disposed on the moving carriage 10. Additionally laying a high voltage wiring for driving the plasma actuator 20 in the flexible cable is not preferable because problems, such as insulation distance, short-circuiting measures, noise countermeasure, and the like, occur.

Therefore, in the present embodiment, a low voltage power source supply line is disposed in the flexible cable, and the driving voltage generation unit 39 is mounted on the head unit 16. The driving voltage generation unit 39 takes the low voltage power source as an input voltage and boosts the voltage to a high voltage in the head unit 16.

In addition, in a case where a piezoelectric element is used as the driving element 36, since the power source supply line for driving the piezoelectric element is laid in the flexible cable, the power source for driving the piezoelectric element may be used as an input voltage of the driving voltage generation unit 39. In addition, even in a case where a thermal type driving element is used as the driving element 36, similarly, a thermal head driving power source can be used as the input voltage of the driving voltage generation unit 39. It is needless to say that an independent low voltage power source line may be laid in the flexible cable.

In addition, when problems, such as insulation distance, short-circuiting measures, noise countermeasures, and the like, do not occur, the high voltage wiring for driving the plasma actuator 20 may be laid in the flexible cable, and for the high voltage wiring, a cable different from the flexible cable for transmitting the head driving signal may be laid.

In this manner, since the driving voltage generation unit 39 is mounted on the head unit 16, it is possible to generate the driving voltage to the plasma actuator 20 driven with a high voltage by the driving voltage generation unit 39. Therefore, it is unnecessary to lay the high voltage wiring in the flexible cable provided in the carriage 10, and problems, such as insulation, short-circuiting measures, noise countermeasures, and the like, do not occur.

As described above, the printing apparatus 1 includes: the ink discharge nozzle row 14b for discharging the ink; the reaction liquid discharge nozzle rows 14a and 14c for discharging the reaction liquid having properties of aggregating the ink; and the plasma actuator 20 that generates the airflow with respect to the platen gap.

Accordingly, since the airflow is generated by the plasma actuator 20 with respect to the platen gap, the mist of the reaction liquid becomes unlikely to adhere to the ink discharge nozzle row 14b, and it is possible to reduce the occurrence of the printing failure due to the mist of the reaction liquid. Further, by providing the plasma actuator 20, it is unnecessary to provide a large-scale airflow generating apparatus additionally, and equipment cost can be reduced.

In addition, the plasma actuator 20 is disposed between the ink discharge nozzle row 14b and the reaction liquid discharge nozzle row 14a. In addition, the plasma actuator 20 is disposed between the ink discharge nozzle row 14b and the reaction liquid discharge nozzle row 14c.

Accordingly, since the plasma actuator 20 is disposed between the ink discharge nozzle row 14b and the reaction liquid discharge nozzle row 14a and between the ink discharge nozzle row 14b and the reaction liquid discharge nozzle row 14c, it is possible to generate the airflow therebetween, and the adhesion of the mist of the reaction liquid becomes unlikely to adhere to the ink discharge nozzle row 14b. Therefore, the printing apparatus 1 can reduce the occurrence of the printing failure due to the mist of the reaction liquid.

In addition, the printing apparatus 1 includes the ink jet head 11 that is mounted on the carriage 10 that reciprocates in the direction intersecting with the transport direction HY1 of the printing medium 3 and has the ink discharge nozzle row 14b.

Accordingly, in the serial type ink jet head 11 mounted on the carriage 10, since the airflow is generated by the plasma actuator 20 with respect to the platen gap, the mist of the reaction liquid becomes unlikely to adhere to the ink discharge nozzle row 14b, and it is possible to reduce the occurrence of the printing failure due to the mist of the reaction liquid.

In addition, the plasma actuator 20 is disposed side by side with the ink discharge nozzle row 14b in the moving direction of the ink jet head 11.

Accordingly, since the plasma actuator 20 is disposed side by side with the ink discharge nozzle row 14b in the moving direction of the ink jet head 11, the mist of the reaction liquid becomes unlikely to adhere to the ink discharge nozzle row 14b disposed in the moving direction of the ink jet head 11, and it is possible to reduce the occurrence of the printing failure due to the mist of the reaction liquid.

In addition, the printing apparatus 1 includes a plurality (two in the present embodiment) of the plasma actuators 20 disposed to interpose the ink discharge nozzle row 14b therebetween.

Accordingly, since the plurality of plasma actuators 20 disposed to interpose the ink discharge nozzle row 14b therebetween are provided, the mist of the reaction liquid becomes unlikely to adhere to the ink discharge nozzle row 14b regardless of the moving direction of the ink jet head 11, and it is possible to reduce the occurrence of the printing failure due to the mist of the reaction liquid.

In addition, the plasma actuator 20 generates the airflow in the discharge direction IY1 in which the ink discharge nozzle row 14b discharges the ink.

Accordingly, since the plasma actuator 20 generates the airflow in the discharge direction IY1 in which the ink discharge nozzle row 14b discharges the ink, the air curtain is formed by the airflow between the ink discharge nozzle row 14b and the reaction liquid discharge nozzle row 14a and between the ink discharge nozzle row 14b and the reaction liquid discharge nozzle row 14c. Therefore, in the printing apparatus 1, the mist of the reaction liquid becomes unlikely to adhere to the ink discharge nozzle row 14b, and it is possible to reduce the occurrence of the printing failure due to the mist of the reaction liquid.

In addition, in the printing apparatus 1, the driving voltage generation unit 39 is mounted on the head unit 16.

Accordingly, it is possible to generate the driving voltage to the plasma actuator 20 driven with a high voltage by the driving voltage generation unit 39. Therefore, it is unnecessary to lay the high voltage wiring in the flexible cable connected to the carriage 10, and problems, such as insulation, short-circuiting measures, noise countermeasures, and the like, do not occur.

### Second Embodiment

Next, a second embodiment will be described.

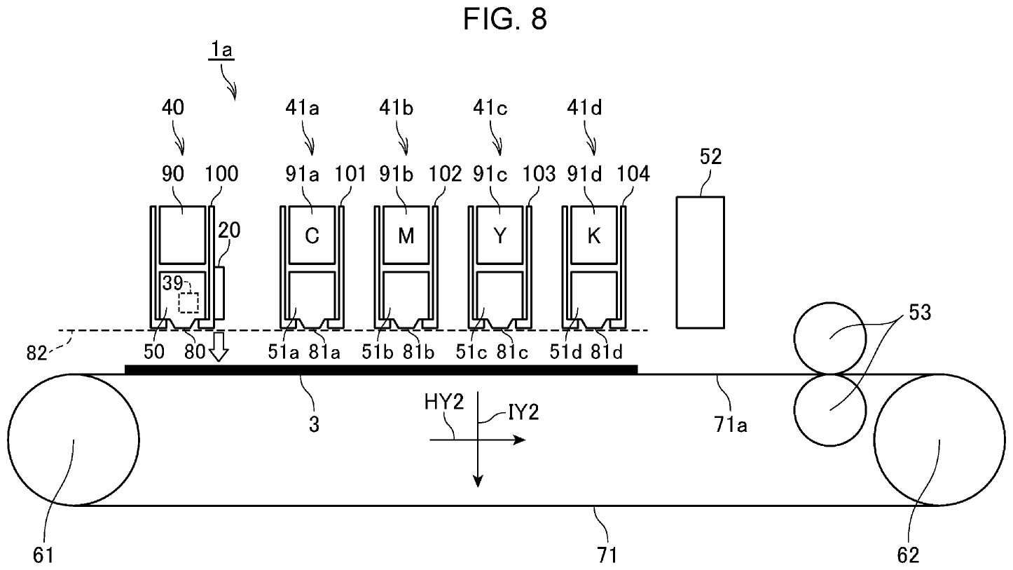

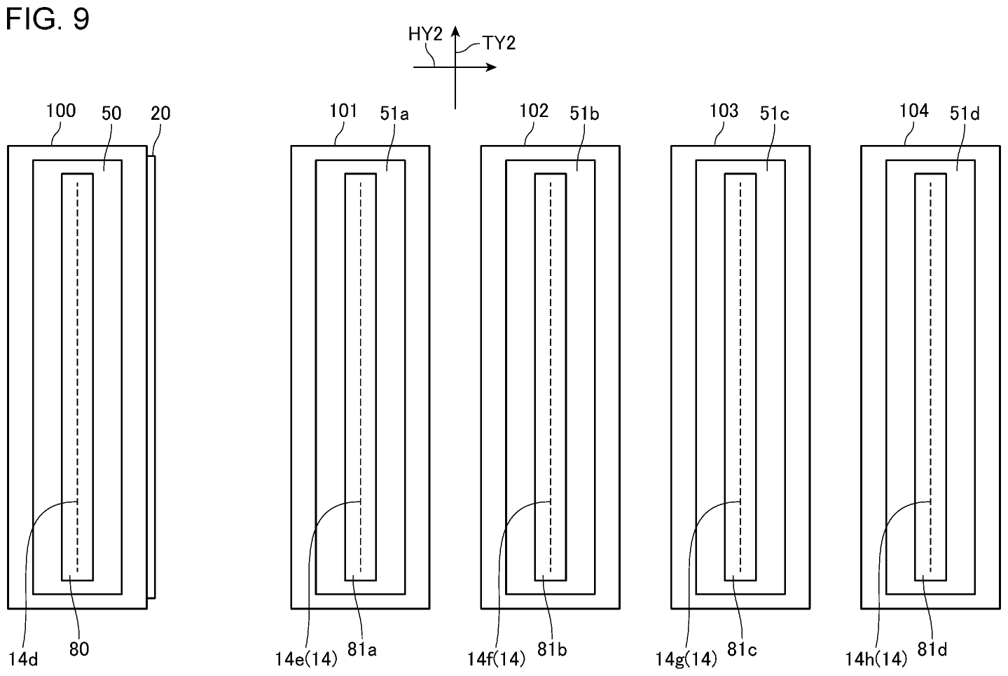

FIG. 8 is a view illustrating an outline of a printing apparatus 1a according to the second embodiment. In addition, FIG. 9 is a schematic view from a liquid discharge surface 82 side of FIG. 8.

As illustrated in FIG. 8, in the printing apparatus 1a, according to the second embodiment, in order from the upstream side in a transport direction HY2 of the printing medium 3, a head unit 40 having a reaction liquid head 50, a head unit 41a having an ink jet head 51a for discharging the cyan ink, a head unit 41b having an ink jet head 51b for discharging the magenta ink, a head unit 41c having an ink jet head 51c for discharging the yellow ink, a head unit 41d having an ink jet head 51d for discharging the black ink, a heating unit 52, and a fixing roller pair 53 are disposed.

The printing medium 3 is held by a transport belt 71 hung between a roller 61 and a roller 62 and transported in the transport direction HY2. In the following description, the transport belt that moves in the transport direction HY2 in the transport belt 71 is referred to as a transport belt 71a.

As illustrated in FIGS. 8 and 9, the reaction liquid head 50 is a line type head and is supported by a supporting member 100. A surface opposing the transport belt 71a of the reaction liquid head 50 is a reaction liquid discharge surface 80. On the reaction liquid discharge surface 80, a reaction liquid discharge nozzle row 14d which is opened to the reaction liquid discharge surface 80 and configured with a plurality of nozzle holes for discharging the reaction liquid having properties of aggregating the ink discharged from each of the ink discharge nozzle rows 14e to 14h which will be described later onto the printing medium 3, is formed. The reaction liquid discharge nozzle row 14d is formed so as to extend in a direction TY2 (intersecting direction) orthogonal to the transport direction HY2 of the printing medium 3.

The reaction liquid head 50 includes the driving element 36, such as a piezoelectric element for discharging the reaction liquid from the reaction liquid discharge nozzle row 14d. In addition, a reaction liquid cartridge 90 for supplying the reaction liquid to the reaction liquid head 50 is mounted on the supporting member 100. The reaction liquid cartridge 90 is a cartridge having a tank for storing the reaction liquid to be discharged from the reaction liquid discharge nozzle row 14d.

The head unit 40 is configured with the supporting member 100, the reaction liquid head 50, and the reaction liquid cartridge 90.

As illustrated in FIG. 8, the ink jet head 51a is a line type head and is supported by a supporting member 101. The surface opposing the transport belt 71a of the ink jet head 51a is an ink discharge surface 81a. On the ink discharge surface 81a, an ink discharge nozzle row 14e which is opened to the ink discharge surface 81a and configured with a plurality of nozzle holes for discharging the cyan ink onto the printing medium 3, is formed. The ink discharge nozzle row 14e is formed so as to extend in the direction TY2 orthogonal to the transport direction HY2 of the printing medium 3. The ink jet head 51a includes the driving element 36, such as a piezoelectric element for discharging the ink from the ink discharge nozzle row 14e. In addition, an ink cartridge 91a for supplying the cyan ink to the ink jet head 51a is mounted on the supporting member 101.

The head unit 41a is configured with the supporting member 101, the ink jet head 51a, and the ink cartridge 91a.

The ink jet head 51b is a line type head and is supported by a supporting member 102. The surface opposing the transport belt 71a of the ink jet head 51b is an ink discharge surface 81b. On the ink discharge surface 81b, an ink discharge nozzle row 14f which is opened to the ink discharge surface 81b and configured with a plurality of nozzle holes for discharging the magenta ink onto the printing medium 3, is formed. The ink discharge nozzle row 14f is formed so as to extend in the direction TY2 orthogonal to the transport direction HY2 of the printing medium 3. The ink jet head 51b includes the driving element 36, such as a piezoelectric element for discharging the ink from the ink discharge nozzle row 14f. In addition, an ink cartridge 91b for supplying the magenta ink to the ink jet head 51b is mounted on the supporting member 102.

The head unit 41b is configured with the supporting member 102, the ink jet head 51b, and the ink cartridge 91b.

The ink jet head 51c is a line type head and is supported by the supporting member 103. The surface opposing the transport belt 71a of the ink jet head 51c is an ink discharge surface 81c. On the ink discharge surface 81c, an ink discharge nozzle row 14g which is opened to the ink discharge surface 81c and configured with a plurality of nozzle holes for discharging the yellow ink onto the printing medium 3, is formed. The ink discharge nozzle row 14g is formed so as to extend in the direction TY2 orthogonal to the transport direction HY2 of the printing medium 3. The ink jet head 51c includes the driving element 36, such as a piezoelectric element for discharging the reaction liquid from the ink discharge nozzle row 14g. In addition, an ink cartridge 91c for supplying the yellow ink to the ink jet head 51c is mounted on the supporting member 103.

The head unit 41c is configured with the supporting member 103, the ink jet head 51c, and the ink cartridge 91c.

The ink jet head 51d is a line type head and is supported by a supporting member 104. The surface opposing the transport belt 71a of the ink jet head 51d is an ink discharge surface 81d. On the ink discharge surface 81d, an ink discharge nozzle row 14h which is opened to the ink discharge surface 81d and configured with a plurality of nozzle holes for discharging the black ink onto the printing medium 3, is formed. The ink discharge nozzle row 14h is formed so as to extend in the direction TY2 orthogonal to the transport direction HY2 of the printing medium 3. The ink jet head 51d includes the driving element 36, such as a piezoelectric element for discharging the reaction liquid from the ink discharge nozzle row 14h. In addition, an ink cartridge 91d for supplying the black ink to the ink jet head 51d is mounted on the supporting member 104.

The head unit 41d is configured with the supporting member 104, the ink jet head 51d, and the ink cartridge 91d.

Here, a gap (space) between the liquid discharge surface 82 and the transport belt 71a, or the gap (space) between the liquid discharge surface 82 and the printing medium 3 also corresponds to the platen gap. In addition, the liquid discharge surface 82 is a surface including the reaction liquid discharge surface 80 and the ink discharge surfaces 81a to 81d.

In the following description, in a case of describing the ink discharge nozzle row 14e to the ink discharge nozzle row 14h as one ink discharge nozzle row without distinction, the ink discharge nozzle rows will be referred to as an ink discharge nozzle row 14.

The plasma actuator 20 is disposed between the reaction liquid discharge nozzle row 14d and the ink discharge nozzle row 14e. The plasma actuator 20 is formed longer than at least one of the length of the reaction liquid discharge nozzle row 14d and the length of the ink discharge nozzle row 14. By doing so, the mist generated from the reaction liquid discharge nozzle row 14d becomes unlikely to adhere to the ink discharge nozzle row 14, and it is possible to reduce the occurrence of the printing failure due to the mist of the reaction liquid. In addition, as illustrated in FIG. 8, the plasma actuator 20 is disposed to generate the airflow in a discharge direction IY2 in which the ink discharge nozzle row 14 discharges the ink. In the present embodiment, the plasma actuator 20 is supported by the supporting member 100. In addition, the support of the plasma actuator 20 may be supported, for example, by being fitted to the reaction liquid head 50, and may be any support as long as the support is disposed between the reaction liquid discharge nozzle row 14d and the ink discharge nozzle row 14e.

The heating unit 52 illustrated in FIG. 8 heats and dries the printing medium 3 onto which the reaction liquid and the ink are discharged.

The fixing roller pair 53 illustrated in FIG. 8 has a plurality of fixing rollers, pressurizes the printing medium 3 with a predetermined pressure, and accordingly fixes the ink discharged onto the printing medium 3 to the printing medium 3. In addition, the fixing roller pair 53 may also serve as both heating and pressing.

Here, a printing operation of the printing apparatus la in the present embodiment will be described.

The printing apparatus 1a discharges the ink by the ink discharge nozzle rows 14e to 14h while transporting the printing medium 3 in the transport direction HY2 while holding the printing medium 3 with the transport belt 71a, and prints the image on the printing medium 3. The printing apparatus 1a discharges the reaction liquid from the reaction liquid discharge nozzle row 14d before the ink is discharged from the ink discharge nozzle rows 14e to 14h. In this manner, since the printing apparatus 1a discharges the reaction liquid, as described above, it is possible to obtain a high-quality printing result even when a plain paper sheet or a recycled paper sheet is used.

However, in the printing method using the reaction liquid, the mist of the reaction liquid is generated between the platen gaps, adheres to the ink discharge nozzle row 14, and there is a possibility that the printing failure occurs. In particular, when the printing medium 3 is transported in the transport direction HY2, there is a case where the airflow that flows in the transport direction HY2 is generated in the platen gap due to the transport of the printing medium 3, and there is a high probability that the mist of the reaction liquid adheres to the ink discharge nozzle row 14 disposed on the downstream side in the transport direction HY2.

Here, the plasma actuator 20 is disposed as illustrated in FIGS. 8 and 9. In other words, the plasma actuator 20 is disposed between the reaction liquid discharge nozzle row 14d and the ink discharge nozzle row 14e. Since the plasma actuator 20 is disposed in this manner, it is possible to generate the airflow between the reaction liquid discharge nozzle row 14d and the ink discharge nozzle row 14e. Therefore, it is possible to suppress the adhesion of the mist of the reaction liquid discharged from the reaction liquid discharge nozzle row 14d to the ink discharge nozzle row 14, and it is possible to reduce the occurrence of the printing failure due to the mist of the reaction liquid.

In addition, as illustrated in FIGS. 8 and 9, the plasma actuator 20 is disposed side by side with the ink discharge nozzle row 14 in the transport direction HY2 of the printing medium 3. Since the plasma actuator 20 is disposed in this manner, it is possible to suppress the adhesion of the mist of the reaction liquid discharged from the reaction liquid discharge nozzle row 14d to the ink discharge nozzle row 14 disposed in the transport direction HY2, it is possible to reduce the occurrence of the printing failure due to a mist of the reaction liquid.

In addition, as illustrated in FIG. 8, the plasma actuator 20 is disposed to generate the airflow in the discharge direction IY2 in which the ink discharge nozzle row 14 discharges the ink. Since the plasma actuator 20 is disposed in this manner, it is possible to form the air curtain between the reaction liquid discharge nozzle row 14d and the ink discharge nozzle row 14e. Therefore, it is possible to suppress the flow of the mist of the reaction liquid to the downstream side in the transport direction HY2. Therefore, the mist of the reaction liquid becomes unlikely to adhere to the ink discharge nozzle row 14, and it is possible to reduce the occurrence of the printing failure due to the mist of the reaction liquid. In addition, since the plasma actuator 20 generates the airflow in the discharge direction IY2 of the ink, it is possible to suppress disturbance of the landing position of the reaction liquid due to the airflow caused by the transport of the printing medium 3.

In the above-described configuration of the printing apparatus 1a, the configuration in a case of discharging the ink of each color including cyan, magenta, yellow, and black onto the printing medium 3 has been exemplified. However, depending on the printing apparatus 1a, in order to print a background image as a base image of an image formed by the ink of each color including cyan, magenta, yellow, and black, there is a case where the background image printing ink is discharged. In this case, the images formed by the ink of each color including cyan, magenta, yellow, and black correspond to a main image to be superimposed and printed on the background image, and the ink of each color including cyan, magenta, yellow, and black corresponds to main image printing ink for printing the main image.

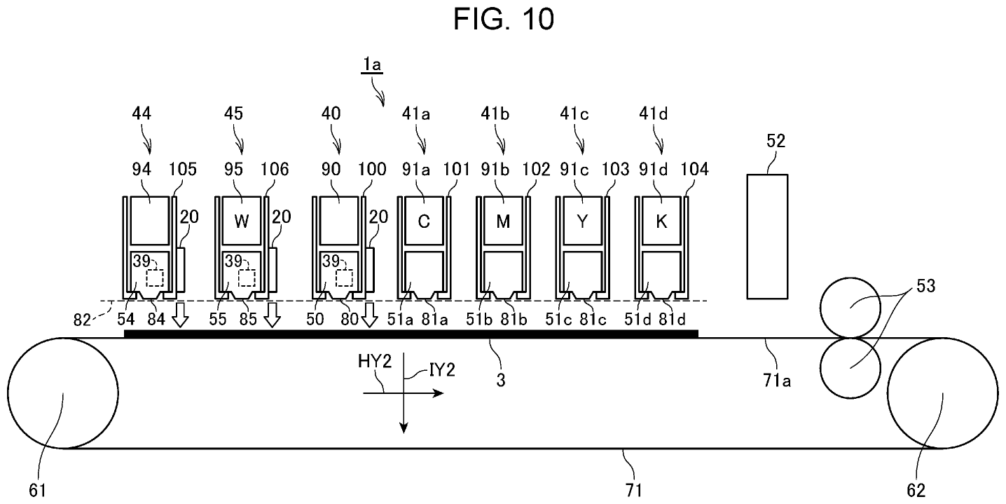

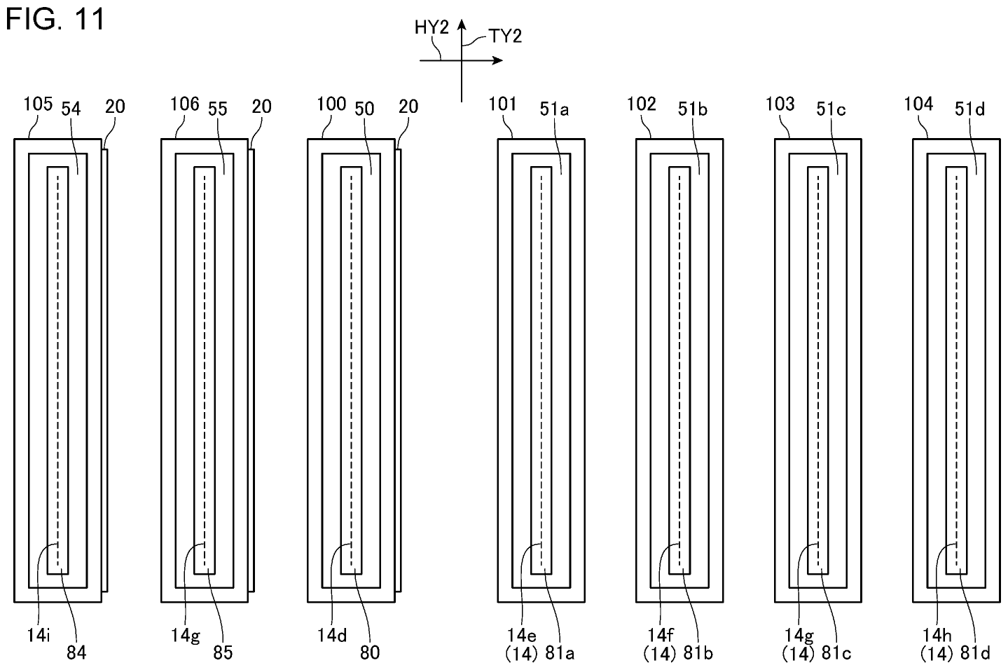

FIG. 10 is a view illustrating an outline of the printing apparatus 1a for discharging the background image printing ink. In addition, FIG. 11 is a schematic view of FIG. 10 when viewed from the liquid discharge surface 82 side. In addition, the same parts as those in FIGS. 8 and 9 will be given the same reference numerals, and the description thereof will be omitted.

As can be apparent by comparing to FIG. 8, in the printing apparatus 1a for discharging the background image printing ink, a head unit 44 having a reaction liquid head 54 and a head unit 45 having an ink jet head 55 for discharging the background image printing ink are disposed further on the upstream side in the transport direction HY2 of the printing medium 3 than the head unit 40. The head unit 44 is disposed further on the upstream side in the transport direction HY2 of the printing medium 3 than the head unit 45.

In the present embodiment, a white (W) ink is exemplified as the background image printing ink.

As illustrated in FIGS. 10 and 11, the reaction liquid head 54 is a line type head and is supported by a supporting member 105. A surface opposing the transport belt 71a of the reaction liquid head 54 is a reaction liquid discharge surface 84. On the reaction liquid discharge surface 84, a reaction liquid discharge nozzle row 14i which is opened to the reaction liquid discharge surface 84 and configured with a plurality of nozzle holes for discharging the reaction liquid having properties of aggregating the ink discharged from the ink discharge nozzle row 14j which will be described later onto the printing medium 3, is formed. The reaction liquid discharge nozzle row 14i is formed so as to extend in the direction TY2 (intersecting direction) orthogonal to the transport direction HY2 of the printing medium 3.

The reaction liquid head 54 includes the driving element, such as a piezoelectric element for discharging the reaction liquid from the reaction liquid discharge nozzle row 14i. In addition, a reaction liquid cartridge 94 for supplying the reaction liquid to the reaction liquid head 54 is mounted on the supporting member 105. The reaction liquid cartridge 94 is a cartridge having a tank for storing the reaction liquid to be discharged from the reaction liquid discharge nozzle row 14i.

The head unit 44 is configured with the supporting member 105, the reaction liquid head 54, and the reaction liquid cartridge 94.

As illustrated in FIG. 10, the ink jet head 55 is a line type head and is supported by a supporting member 106. A surface opposing the transport belt 71a of the ink jet head 55 is an ink discharge surface 85. On the ink discharge surface 85, an ink discharge nozzle row 14j which is opened to the ink discharge surface 85 and configured with a plurality of nozzle holes for discharging the white ink onto the printing medium 3, is formed. The ink discharge nozzle row 14j is formed so as to extend in the direction TY2 orthogonal to the transport direction HY2 of the printing medium 3. The ink jet head 55 includes the driving element, such as a piezoelectric element for discharging the reaction liquid from the ink discharge nozzle row 14j. In addition, an ink cartridge 95 for supplying the white ink to the ink jet head 55 is mounted on the supporting member 106.

The head unit 45 is configured with the supporting member 106, the ink jet head 55, and the ink cartridge 95.

Unlike the reaction liquid discharged from the reaction liquid discharge nozzle row 14d, the reaction liquid discharged from the reaction liquid discharge nozzle row 14i is a reaction liquid having properties of aggregating the white ink discharged from the ink discharge nozzle row 14j. In other words, the reaction liquid discharged from the reaction liquid discharge nozzle row 14i is a reaction liquid having properties of aggregating the white ink as the background image printing ink. In addition, the reaction liquid discharged from the reaction liquid discharge nozzle row 14d is a reaction liquid having properties of aggregating the cyan, magenta, yellow, and black inks as the main image printing ink.

In addition, in the present embodiment, the reaction liquid discharge nozzle row 14i corresponds to a first reaction liquid discharge nozzle row since the reaction liquid discharge nozzle row 14i discharges the reaction liquid having properties of aggregating the white ink as the background image printing ink. In addition, the ink discharge nozzle row 14j corresponds to a first ink discharge nozzle row since the ink discharge nozzle row 14j discharges the white ink as the background image printing ink. Further, the reaction liquid discharge nozzle row 14d corresponds to a second ink discharge nozzle row since the reaction liquid discharge nozzle row 14d discharges the reaction liquid having properties of aggregating the cyan, magenta, yellow, and black inks as the main image printing ink. In addition, the ink discharge nozzle row 14 corresponds to a second ink discharge nozzle row since the ink discharge nozzle row 14 discharges the cyan, magenta, yellow, and black inks as the main image printing ink.

Here, a gap (space) between the liquid discharge surface 82 and the transport belt 71a, or the gap (space) between the liquid discharge surface 82 and the printing medium 3 also corresponds to the platen gap. In addition, in FIG. 10, the liquid discharge surface 82 is a surface including the reaction liquid discharge surface 80, the ink discharge surfaces 81a to 81d, the reaction liquid discharge surface 84, and the ink discharge surface 85.

The plasma actuator 20 is disposed between the reaction liquid discharge nozzle row 14i and the ink discharge nozzle row 14j. The plasma actuator 20 is formed longer than at least one of the length of the reaction liquid discharge nozzle row 14i and the length of the ink discharge nozzle row 14j. By doing so, the mist generated from the reaction liquid discharge nozzle row 14i becomes unlikely to adhere to the ink discharge nozzle row 14j, and it is possible to reduce the occurrence of the printing failure due to the mist of the reaction liquid. In addition, as illustrated in FIG. 8, the plasma actuator 20 is disposed to generate the airflow in the discharge direction IY2 of the ink. In the present embodiment, the plasma actuator 20 is supported by the supporting member 105. In addition, the support of the plasma actuator 20 may be supported, for example, by being fitted to the reaction liquid head 54, and may be any support as long as the support is disposed between the reaction liquid discharge nozzle row 14i and the ink discharge nozzle row 14j.

In addition, the plasma actuator 20 is disposed between the ink discharge nozzle row 14j and the reaction liquid discharge nozzle row 14d. The plasma actuator 20 is formed longer than at least one of the length of the reaction liquid discharge nozzle row 14d and the length of the ink discharge nozzle row 14. By doing so, the mist generated from the reaction liquid discharge nozzle row 14d becomes unlikely to adhere to the ink discharge nozzle row 14, and it is possible to reduce the occurrence of the printing failure due to the mist of the reaction liquid. In addition, as illustrated in FIG. 10, the plasma actuator 20 is disposed to generate the airflow in the discharge direction IY2 of the ink. In the present embodiment, the plasma actuator 20 is supported by the supporting member 106. In addition, the support of the plasma actuator 20 may also be any support as long as the support is disposed between the reaction liquid discharge nozzle row 14d and the ink discharge nozzle row 14j.

Here, a printing operation of the printing apparatus la illustrated in FIG. 10 will be described.

The printing apparatus 1 transports the printing medium 3 in the transport direction HY2 while holding the printing medium 3 with the transport belt 71a of the printing medium 3. The printing apparatus 1a discharges the reaction liquid from the reaction liquid discharge nozzle row 14i onto the printing medium 3. In addition, the printing apparatus la discharges the white ink from the ink discharge nozzle row 14j onto the discharged reaction liquid and prints a background image on the printing medium 3. Thereafter, in the printing apparatus 1a, the reaction liquid is discharged from the reaction liquid discharge nozzle row 14d onto the printing medium 3, discharges the ink from the ink discharge nozzle rows 14e to 14h onto the reaction liquid, and accordingly prints a main image superimposing the ink on the background image.

As described above, in the printing method using the reaction liquid, the mist of the reaction liquid is generated between the platen gaps, adheres to the ink discharge nozzle row 14, and there is a possibility that the printing failure occurs. In particular, when printing the background image, since the background image printing ink is discharged in the entire printing region of the printing medium 3, the mist of the background image printing ink is generated more than the mist of the main image printing ink. Therefore, compared to the ink discharge nozzle row 14 for discharging the main image printing ink, there is a higher probability that the printing failure occurs due to the mist of the reaction liquid in the ink discharge nozzle row 14j for discharging the background image printing ink.

Here, the plasma actuator 20 is disposed as illustrated in FIGS. 10 and 11. In other words, the plasma actuator 20 is disposed between the reaction liquid discharge nozzle row 14i and the ink discharge nozzle row 14j and between the reaction liquid discharge nozzle row 14d and the ink discharge nozzle row 14. Since the plasma actuator 20 is disposed in this manner, it is possible to generate the airflow between the reaction liquid discharge nozzle row 14i and the ink discharge nozzle row 14j and between the reaction liquid discharge nozzle row 14d and the ink discharge nozzle row 14. Therefore, it is possible to suppress the adhesion of the mist of the reaction liquid discharged from the reaction liquid discharge nozzle row 14i to the ink discharge nozzle row 14j, it is possible to suppress the adhesion of the mist of the reaction liquid discharged from the reaction liquid discharge nozzle row 14d to the ink discharge nozzle row 14, and it is possible to reduce the occurrence of the printing failure due to the mist of the reaction liquid.

In addition, as illustrated in FIG. 10, the plasma actuator 20 generates the airflow in the discharge direction IY2 of the ink. Since the plasma actuator 20 is disposed in this manner, the air curtain is formed between the reaction liquid discharge nozzle row 14i and the ink discharge nozzle row 14j, and the air curtain is formed between the reaction liquid discharge nozzle row 14d and the ink discharge nozzle row 14. Therefore, it is possible to suppress the flow of the mist of the reaction liquid to the downstream side in the transport direction HY2. Therefore, the mist of the reaction liquid discharged from the reaction liquid discharge nozzle row 14i becomes unlikely to adhere to the ink discharge nozzle row 14j, the mist of the reaction liquid discharged from the reaction liquid discharge nozzle row 14d becomes unlikely to adhere to the ink discharge nozzle row 14, and it is possible to reduce the occurrence of the printing failure due to the mist of the reaction liquid. In addition, since the plasma actuator 20 is disposed to generate the airflow in the discharge direction IY2 of the ink, it is possible to suppress disturbance of the landing position of the reaction liquid by the transport of the printing medium 3.

In addition, since the background image is often printed in a wider range than the main image, the discharge amount of the background image printing ink is often larger than the discharge amount of the main image printing ink. Therefore, since the discharge amount of the reaction liquid that corresponds to the background image printing ink is also large, a large amount of mist is generated. Therefore, the airflow of the plasma actuator 20 disposed between the reaction liquid discharge nozzle row 14i and the ink discharge nozzle row 14j is set to have a larger air volume than that of the airflow of the plasma actuator 20 disposed between the reaction liquid discharge nozzle row 14d and the ink discharge nozzle row 14.

Accordingly, it is possible to suppress the adhesion of the mist of the reaction liquid discharged from the reaction liquid discharge nozzle row 14i to the ink discharge nozzle row 14j. As described above, compared to the ink discharge nozzle row 14 for discharging the main image printing ink, there is a higher probability that the printing failure occurs due to the mist of the reaction liquid in the ink discharge nozzle row 14j. However, the airflow of the plasma actuator 20 disposed between the reaction liquid discharge nozzle row 14i and the ink discharge nozzle row 14j is set to have a larger air volume than that of the airflow of the plasma actuator 20 disposed between the reaction liquid discharge nozzle row 14d and the ink discharge nozzle row 14. Therefore, even in a case where a large amount of mist is generated similar to the background image printing ink, it is possible to reliably reduce the printing failure due to the mist of the reaction liquid.

Here, it is considered that the air volume of the airflow of the plasma actuator 20 disposed between the reaction liquid discharge nozzle row 14d and the ink discharge nozzle row 14 is set to be large in accordance with the air volume of the airflow of the plasma actuator 20 disposed between the reaction liquid discharge nozzle row 14i and the ink discharge nozzle row 14j. However, as described above, since the plasma actuator 20 requires a high voltage to drive, when the air volume of the airflow of the plasma actuator 20 disposed between the reaction liquid discharge nozzle row 14i and the ink discharge nozzle row 14j and the air volume of the airflow of the plasma actuator 20 disposed between the reaction liquid discharge nozzle row 14d and the ink discharge nozzle row 14 are set to be the same as each other, there is a concern regarding the power consumption. In the present embodiment, by setting the airflow of the plasma actuator 20 disposed between the reaction liquid discharge nozzle row 14i and the ink discharge nozzle row 14j to be larger than the airflow of the plasma actuator 20 disposed between the reaction liquid discharge nozzle row 14d and the ink discharge nozzle row 14, after suppressing the power consumption, it is possible to reduce the occurrence of the printing failure due to the mist of the reaction liquid.

In addition, as illustrated in FIG. 10, the plasma actuator 20 is disposed between the ink discharge nozzle row 14j and the reaction liquid discharge nozzle row 14d. Therefore, it is possible to suppress the flow of the mist of the background image printing ink discharged from the ink discharge nozzle row 14j to the downstream side in the transport direction HY2 of the printing medium 3. Therefore, even in a case where the background image printing ink is aggregated due to the reaction liquid discharged from the reaction liquid discharge nozzle row 14d, since it is possible to suppress the adhesion of the mist of the background image printing ink to the ink discharge nozzle row 14, it is possible to reduce the occurrence of the printing failure due to the reaction liquid. Further, it is possible to suppress the adhesion of the mist of the background image printing ink to the reaction liquid discharge nozzle row 14d.

The functional configuration of the printing apparatus 1a in the present embodiment is the same as the configuration except for the carriage driver 33 and the carriage motor 37 in FIG. 7.

Therefore, the printing apparatus 1a includes the driving voltage generation unit 39 for driving the plasma actuator 20. In the present embodiment, the driving voltage generation unit 39 is mounted on each of the head unit 40, the head unit 44, and the head unit 45. In a case of being mounted on the head unit 40, the driving voltage generation unit 39 is supported by the supporting member 100, for example. In addition, in a case of being mounted on the head unit 44, the driving voltage generation unit 39 is supported by the supporting member 105, for example. In a case of being mounted on the head unit 45, the driving voltage generation unit 39 is supported by the supporting member 106, for example.

At least the head unit 40, the head unit 44, and the head unit 45 are provided with the flexible cable for transmitting the head driving signal. Additionally laying a high voltage wiring for driving the plasma actuator 20 in the flexible cable is not preferable because problems, such as insulation distance, short-circuiting measures, noise countermeasure, and the like, occur. Here, in the present embodiment, the low voltage power source supply line is disposed in the flexible cable, and the driving voltage generation unit 39 is mounted on the head unit 40, the head unit 44, and the head unit 45. The driving voltage generation unit 39 takes the low voltage power source as an input voltage and boosts the voltage to a high voltage in the head unit 40, the head unit 44, and the head unit 45.

In this manner, since the driving voltage generation unit 39 is mounted on the head unit 40, the head unit 44, and the head unit 45, it is possible to generate the driving voltage to the plasma actuator 20 driven with a high voltage by the driving voltage generation unit 39. Therefore, it is unnecessary to lay the high voltage wiring in the flexible cable in the head unit 40, the head unit 44, and the head unit 45, and problems, such as insulation, short-circuiting measures, noise countermeasure, and the like, do not occur.

As described above, the printing apparatus 1a of the present embodiment includes the ink jet heads 51a to 51d provided with the ink discharge nozzle row 14 that extends in the direction TY2 (intersecting direction) orthogonal to the transport direction HY2 of the printing medium 3.

Accordingly, in the printing apparatus 1a including the ink jet heads 51a to 51d provided with the ink discharge nozzle row 14 that extends in the direction TY2, since the airflow is generated by the plasma actuator 20 with respect to the platen gap, the mist of the reaction liquid becomes unlikely to adhere to the ink discharge nozzle row 14, and it is possible to reduce the occurrence of the printing failure due to the mist of the reaction liquid.

In addition, the plasma actuator 20 is disposed side by side with the ink discharge nozzle row 14 in the transport direction HY2 of the printing medium 3.

Accordingly, since the plasma actuator 20 is disposed side by side with the ink discharge nozzle row 14 in the transport direction HY2 of the printing medium 3, the mist of the reaction liquid becomes unlikely to adhere to the ink discharge nozzle row 14 disposed in the transport direction HY2, and it is possible to reduce the occurrence of the printing failure due to the mist of the reaction liquid.

In addition, the plasma actuator 20 generates the airflow in the discharge direction IY2 in which the ink discharge nozzle row 14 discharges the ink.

Accordingly, since the plasma actuator 20 generates the airflow in the discharge direction IY2 in which the ink discharge nozzle row 14 discharges the ink, the air curtain is formed between the ink discharge nozzle row 14 and the reaction liquid discharge nozzle row 14d, the mist of the reaction liquid becomes unlikely to adhere to the ink discharge nozzle row 14, and it is possible to reduce the occurrence of the printing failure due to the mist of the reaction liquid.

In addition, the printing apparatus 1a includes the ink discharge nozzle row 14j (first ink discharge nozzle row) for discharging the background image printing ink for printing the background image, and the ink discharge nozzle row 14 (second ink discharge nozzle row) for discharging the main image printing ink for printing the main image, as the ink discharge nozzle row. In addition, the printing apparatus 1a includes the reaction liquid discharge nozzle row 14i (first ink discharge nozzle row) for discharging the reaction liquid having properties of aggregating the background image printing ink, and the reaction liquid discharge nozzle row 14d (second reaction liquid discharge nozzle row) for discharging the reaction liquid having properties of aggregating the main image printing ink, as the reaction liquid discharge nozzle row. In addition, the plasma actuator 20 is disposed between the ink discharge nozzle row 14j and the reaction liquid discharge nozzle row 14i and between the ink discharge nozzle row 14 and the reaction liquid discharge nozzle row 14d.

In this manner, the plasma actuator 20 is disposed between the ink discharge nozzle row 14j and the reaction liquid discharge nozzle row 14i and between the ink discharge nozzle row 14 and the reaction liquid discharge nozzle row 14d. Therefore, the mist of the reaction liquid that aggregates the background image printing ink becomes unlikely to adhere to the ink discharge nozzle row 14j, the mist of the reaction liquid that aggregates the main image printing ink becomes unlikely to adhere to the ink discharge nozzle row 14, and it is possible to reduce the occurrence of the printing failure due to the mist of each reaction liquid.

In addition, the plasma actuator 20 disposed between the ink discharge nozzle row 14j and the reaction liquid discharge nozzle row 14i generates the airflow having a larger air volume than that of the airflow generated by the plasma actuator 20 disposed between the ink discharge nozzle row 14 and the reaction liquid discharge nozzle row 14d.

In this manner, the plasma actuator 20 disposed between the ink discharge nozzle row 14j and the reaction liquid discharge nozzle row 14i generates the airflow having a larger air volume than that of the airflow generated by the plasma actuator 20 disposed between the ink discharge nozzle row 14 and the reaction liquid discharge nozzle row 14d. Therefore, the mist of the reaction liquid that aggregates the background image printing ink becomes unlikely to adhere to the ink discharge nozzle row 14j and the ink discharge nozzle row 14, and it is possible to reduce the occurrence of the printing failure due to the mist of the reaction liquid that aggregates the background image printing ink.

In addition, the printing apparatus 1a includes the head unit 45 having the driving voltage generation unit 39 and the ink discharge nozzle row 14j.

Accordingly, it is possible to generate the driving voltage to the plasma actuator 20 driven with a high voltage by the driving voltage generation unit 39. Therefore, it is unnecessary to lay the high voltage wiring in the flexible cable disposed in the head unit 45, and problems, such as insulation, short-circuiting measures, noise countermeasures, and the like, do not occur.

In addition, the printing apparatus 1a includes the head unit 40 having the driving voltage generation unit 39 and the reaction liquid discharge nozzle row 14d. In addition, the printing apparatus 1a includes the head unit 44 having the driving voltage generation unit 39 and the reaction liquid discharge nozzle row 14i.

Accordingly, it is possible to generate the driving voltage to the plasma actuator 20 driven with a high voltage by the driving voltage generation unit 39. Therefore, it is unnecessary to lay the high voltage wiring in the flexible cable disposed in the head unit 40 and the head unit 44, and problems, such as insulation, short-circuiting measures, noise countermeasure, and the like, do not occur.

In addition, in the present embodiment, the ink jet heads 50 to 51 are described as extending in the direction orthogonal to the transport direction HY2, but may not be necessarily orthogonal. The nozzle row may be disposed to cover the printing region of the printing medium 3.

In addition, in the present embodiment, a case where the plasma actuator 20 generates the airflow in the discharge direction IY2 of the ink has been exemplified, but when it is possible to suppress the adhesion of the mist of the reaction liquid discharged from the reaction liquid discharge nozzle row 14d to the ink discharge nozzle row 14, the direction in which the airflow is generated is not limited to the discharge direction IY2 of the ink. Further, as long as it is possible to suppress the adhesion of the mist of the reaction liquid discharged from the reaction liquid discharge nozzle row 14i to the ink discharge nozzle row 14j, the direction in which the airflow is generated is not limited to the discharge direction IY2 of the ink.

For example, the plasma actuator 20 disposed between the reaction liquid discharge nozzle row 14d and the ink discharge nozzle row 14 may be configured to generate the airflow in the direction opposite to the transport direction HY2 of the printing medium 3. Accordingly, it is possible to suppress the adhesion of the mist of the reaction liquid discharged from the reaction liquid discharge nozzle row 14d to the ink discharge nozzle row 14.

In addition, for example, the plasma actuator 20 disposed between the reaction liquid discharge nozzle row 14i and the ink discharge nozzle row 14j may be configured to generate the airflow in the direction opposite to the transport direction HY2 of the printing medium 3. Accordingly, it is possible to suppress the adhesion of the mist of the reaction liquid discharged from the reaction liquid discharge nozzle row 14i to the ink discharge nozzle row 14j.

Further, the configurations may be combined with each other.

### Third Embodiment

Next, a third embodiment will be described.

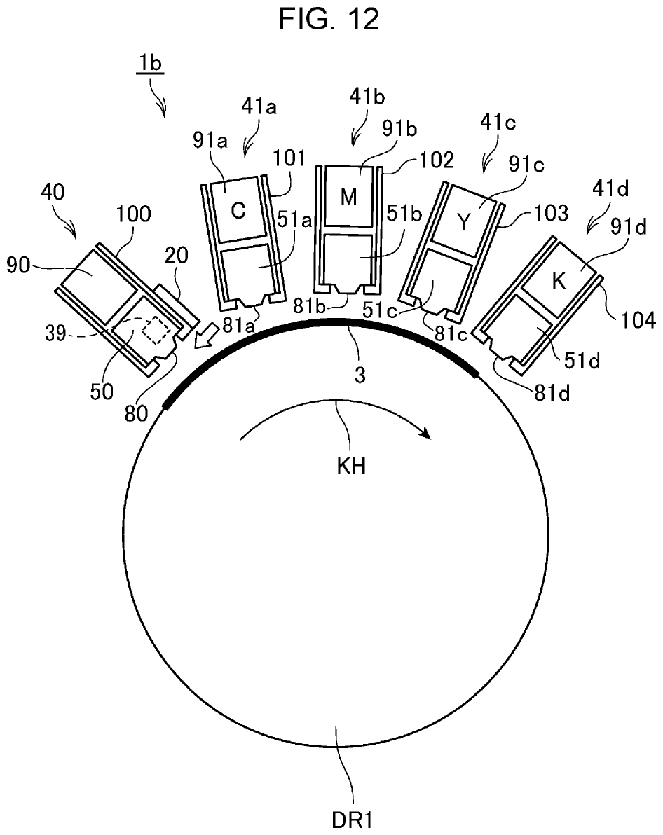

FIG. 12 is a view illustrating an outline of a printing apparatus 1b according to the third embodiment. The same part as that in the printing apparatus 1b according to the second embodiment will be given the same reference numerals, and the detailed description thereof will be omitted.

As can be apparent by comparing to the printing apparatus 1b according to the second embodiment, the printing apparatus 1b according to the third embodiment includes a rotary drum DR1, and transports the printing medium 3 in a rotational direction KH of the drum DR1 according to the rotation of the drum DR1.

Further, in the printing apparatus 1b according to the third embodiment, in order from the upstream side in the rotational direction KH, the head unit 40, the head unit 41a, the head unit 41b, the head unit 41c, and the head unit 41d are disposed.

The head unit 40 is disposed such that the reaction liquid discharge surface 80 opposes the surface of the drum DR1. On the reaction liquid discharge surface 80, the reaction liquid discharge nozzle row 14d is formed. In addition, the head unit 41a is disposed such that the ink discharge surface 81a opposes the surface of the drum DR1. On the ink discharge surface 81a, the ink discharge nozzle row 14e is formed. In addition, the head unit 41b is disposed such that the ink discharge surface 81b opposes the surface of the drum DR1. On the ink discharge surface 81b, the ink discharge nozzle row 14f is formed. In addition, the head unit 41c is disposed such that the ink discharge surface 81c opposes the surface of the drum DR1. On the ink discharge surface 81c, the ink discharge nozzle row 14g is formed. In addition, the head unit 41d is disposed such that the ink discharge surface 81d opposes the surface of the drum DR1. On the ink discharge surface 81d, the ink discharge nozzle row 14h is formed.

In the present embodiment, the gap (space) between the reaction liquid discharge surface 80 and the surface of the drum DR1 opposing the reaction liquid discharge surface 80, or the gap (space) between the reaction liquid discharge surface 80 and the printing medium 3 also corresponds to the platen gap. In addition, the gap (space) between the ink discharge surface 81a and the surface of the drum DR1 opposing the ink discharge surface 81a, or the gap (space) between the ink discharge surface 81a and the printing medium 3 also corresponds to the platen gap. In addition, the gap (space) between the ink discharge surface 81b and the surface of the drum DR1 opposing the ink discharge surface 81b, or the gap (space) between the ink discharge surface 81b and the printing medium 3 also corresponds to the platen gap. In addition, the gap (space) between the ink discharge surface 81c and the surface of the drum DR1 opposing the ink discharge surface 81c, or the gap (space) between the ink discharge surface 81c and the printing medium 3 also corresponds to the platen gap. In addition, the gap (space) between the ink discharge surface 81d and the surface of the drum DR1 opposing the ink discharge surface 81d, or the gap (space) between the ink discharge surface 81d and the printing medium 3 also corresponds to the platen gap.

In the printing apparatus 1b according to the third embodiment, the reaction liquid is discharged from the head unit 40 onto the printing medium 3 transported in the rotational direction KH, and the ink is discharged from the head unit 41a to the head unit 41d on the discharged reaction liquid.

In a case of the printing apparatus 1b which transports the printing medium 3 by the drum DR1, the plasma actuator 20 is disposed between the reaction liquid discharge nozzle row 14d and the ink discharge nozzle row 14. In addition, the plasma actuator 20 generates the airflow in the direction opposite to the rotational direction of the drum DR1.

Due to the rotation of the drum DR1, there is a case where the airflow is generated in the rotational direction KH in the platen gap due to the rotation. Therefore, there is case where the mist of the reaction liquid discharged from the head unit 40 flows in the rotational direction KH of the drum DR1 and adheres to the ink discharge nozzle row 14 positioned on the downstream side in the rotational direction KH. However, since the plasma actuator 20 is disposed between the reaction liquid discharge nozzle row 14d and the ink discharge nozzle row 14, it is possible to suppress the adhesion of the mist of the reaction liquid to the ink discharge nozzle row 14, and it is possible to reduce the occurrence of the printing failure due to the reaction liquid.

In addition, the plasma actuator 20 generates the airflow in the direction opposite to the rotational direction of the drum DR1. Accordingly, it is possible to suppress the airflow in the rotational direction KH caused by the rotation of the drum DR1 in the platen gap, and to suppress the flow of the mist of the reaction liquid to the ink discharge nozzle row 14 positioned on the downstream side in the rotational direction KH. In other words, in the printing apparatus 1b, it is possible to suppress the adhesion of the mist of the reaction liquid to the ink discharge nozzle row 14, and it is possible to reduce the occurrence of the printing failure due to the mist of the reaction liquid.

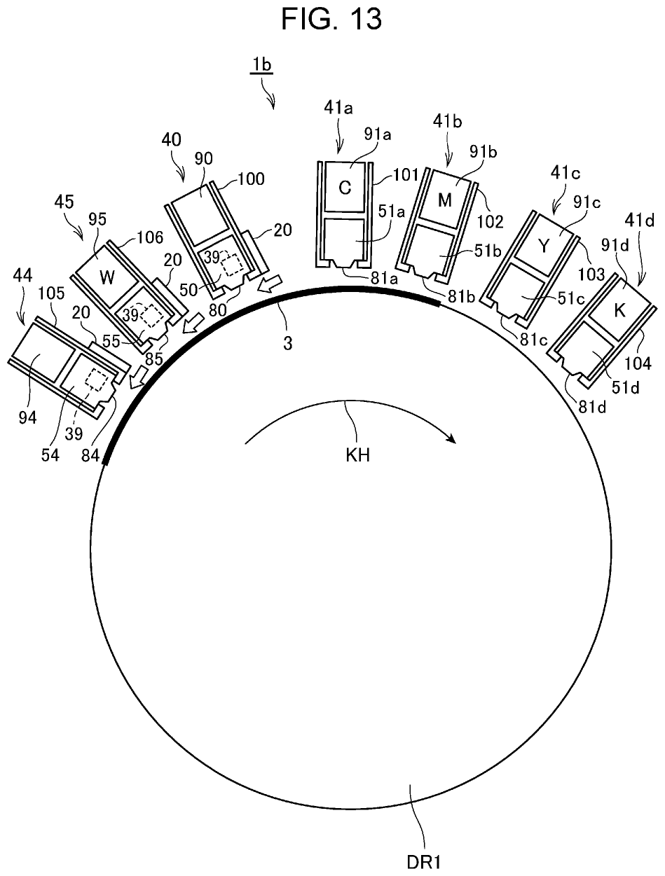

FIG. 13 is a view illustrating an outline of the printing apparatus 1b according to the third embodiment for discharging the background image printing ink. In FIG. 13, the same parts as those in FIGS. 10 and 12 will be given the same reference numerals, and the detailed description thereof will be omitted.

In a case of discharging the background image printing ink, in the printing apparatus 1b, the head unit 44 and the head unit 45 are disposed on the upstream side in the rotational direction KH of the head unit 40. The head unit 44 is disposed further on the upstream side in the rotational direction KH than the head unit 45.

The head unit 44 is disposed such that the reaction liquid discharge surface 84 opposes the surface of the drum DR1. On the reaction liquid discharge surface 84, the reaction liquid discharge nozzle row 14i is formed. In addition, the head unit 45 is disposed such that the ink discharge surface 85 opposes the surface of the drum DR1. On the ink discharge surface 85, the ink discharge nozzle row 14j is formed.

Here, the gap (space) between the reaction liquid discharge surface 84 and the surface of the drum DR1 opposing the reaction liquid discharge surface 84, or the gap (space) between the reaction liquid discharge surface 84 and the printing medium 3 also corresponds to the platen gap. In addition, the gap (space) between the ink discharge surface 85 and the surface of the drum DR1 opposing the ink discharge surface 85, or the gap (space) between the ink discharge surface 85 and the printing medium 3 also corresponds to the platen gap.

In a case of the printing apparatus 1b illustrated in FIG. 13, the plasma actuator 20 is disposed between the reaction liquid discharge nozzle row 14i and the ink discharge nozzle row 14j and between the reaction liquid discharge nozzle row 14d and the ink discharge nozzle row 14. In addition, each of the plasma actuators 20 generates the airflow in the direction opposite to the rotational direction of the drum DR1.

In this manner, the plasma actuator 20 is disposed to generate the airflow in the direction opposite to the rotational direction of the drum DR1. Accordingly, even in a case where the printing apparatus 1b is provided with the rotary drum DR1 and discharges the background image printing ink, the same effect as the effect described in the second embodiment is exerted.

The functional configuration of the printing apparatus 1 in the present embodiment is the same as the functional configuration of the printing apparatus 1b in the second embodiment.

Therefore, the printing apparatus 1b includes the driving voltage generation unit 39 for driving the plasma actuator 20. In the present embodiment, the driving voltage generation unit 39 is mounted on each of the head unit 40, the head unit 44, and the head unit 45. In a case of being mounted on the head unit 40, the driving voltage generation unit 39 is supported by the supporting member 100, for example. In addition, in a case of being mounted on the head unit 44, the driving voltage generation unit 39 is supported by the supporting member 105, for example. In a case of being mounted on the head unit 45, the driving voltage generation unit 39 is supported by the supporting member 106, for example.

At least the head unit 40, the head unit 44, and the head unit 45 are provided with the flexible cable for transmitting the head driving signal. Additionally laying a high voltage wiring for driving the plasma actuator 20 in the flexible cable is not preferable because problems, such as insulation distance, short-circuiting measures, noise countermeasure, and the like, occur. Therefore, in the present embodiment, the low voltage power source supply line is disposed in the flexible cable, and the driving voltage generation unit 39 is mounted on the head unit 40, the head unit 44, and the head unit 45. The driving voltage generation unit 39 takes the low voltage power source as an input voltage and boosts the voltage to a high voltage in the head unit 40, the head unit 44, and the head unit 45.

In this manner, since the driving voltage generation unit 39 is mounted on the head unit 40, the head unit 44, and the head unit 45, it is possible to generate the driving voltage to the plasma actuator 20 driven with a high voltage by the driving voltage generation unit 39. Therefore, it is unnecessary to lay the high voltage wiring in the flexible cable in the head unit 40, the head unit 44, and the head unit 45, and problems, such as insulation, short-circuiting measures, noise countermeasure, and the like, do not occur.

In addition, in the present embodiment, a case where the plasma actuator 20 generates the airflow in the direction opposite to the rotational direction KH of the drum DR1 has been exemplified, but when it is possible to suppress the occurrence of printing failure due to the reaction liquid, the configuration is not limited to the configuration in which the airflow is generated in the direction opposite to the rotational direction KH of the drum DR1. For example, the airflow generated by the plasma actuator 20 may be a surface direction of the drum DR1. Even in this direction, it is possible to suppress the flow of the mist of the reaction liquid on the downstream side in the rotational direction KH of the drum DR1, and thus, it is possible to reduce the occurrence of the printing failure due to the reaction liquid.

Further, in the present embodiment, a configuration in which, in the vicinity of one drum DR1, the head unit 40 and the head units 41a to 41d are disposed, has been exemplified. However, the drum on which the head unit 40 and the head units 41a to 41d are disposed may be different. In this case, in the printing apparatus 1b, in order from the upstream side in the transport direction of the printing medium 3, the drum on which the head unit 40 is disposed and the drum on which the head units 41a to 41d are disposed are disposed.

Further, in the present embodiment, a configuration in which, in the vicinity of one drum DR1, from the upstream side in the rotational direction KH, the head unit 44, the head unit 45, the head unit 40, and the head units 41a to 41d are disposed, has been exemplified. However, the drum on which the head unit 44 and the head unit 45 are disposed and the drum on which the head unit 40 and the head units 41a to 41d are disposed may be different. In this case, in the printing apparatus 1b, in order from the upstream side in the transport direction of the printing medium 3, the drum on which the head unit 44 and the head unit 45 are disposed and the drum on which the head unit 40 and the head units 41a to 41d are disposed are disposed.

As described above, the printing apparatus 1b includes the rotary drum DR1 that transports the printing medium 3. The plasma actuator 20 generates the airflow in the direction opposite to the rotational direction KH in which the drum DR1 rotates.

Accordingly, in a configuration in which the printing apparatus 1b includes the drum DR1, since the plasma actuator 20 generates the airflow in the direction opposite to the rotational direction KH in which the drum DR1 rotates, the mist of the reaction liquid becomes unlikely to adhere to the ink discharge nozzle row 14b, and it is possible to reduce the occurrence of the printing failure due to the mist of the reaction liquid.

Each of the above-described embodiments merely illustrate one aspect of the present invention, and any modifications and applications are possible within the scope of the present invention.

For example, in the above-described first embodiment, a configuration in which the printing apparatus 1 discharges the cyan, magenta, yellow, and black inks onto the printing medium 3 and prints the image on the printing medium 3 has been exemplified. However, similar to the printing apparatus 1a in the second embodiment and the printing apparatus 1b in the third embodiment, the printing apparatus 1 in the first embodiment may also be configured to print the background image on the printing medium 3. In this case, the ink jet head for discharging the background image printing ink and the reaction head for discharging the reaction liquid having properties of aggregating the background image printing ink are mounted on the head unit 16. In addition, the plasma actuator 20 is appropriately disposed such that it is possible to suppress the adhesion of the mist of the reaction liquid having properties of aggregating the background image printing ink to the ink discharge nozzle row for discharging the background image printing ink. In addition, the ink jet head for discharging the background image printing ink and the reaction head for discharging the reaction liquid having properties of aggregating the background image printing ink may be integrated with the ink jet head 11.

Further, in each of the above-described embodiments, the same reaction liquid may be used even when different reaction liquids are used as the reaction liquid that aggregates the background image ink and the reaction liquid that aggregates the main image ink.

In addition, in each of the above-described embodiments, a case of superimposing and printing the main image after printing the background image in order to print a printed material that is visually recognized from the printing surface side has been described, but there is also a case of superimposing and printing the background image after printing the main image first in order to print the printed material that is visually recognized from the side opposite to the printing surface. In this case, a nozzle row for printing the main image is disposed on the upstream side in the moving direction of the carriage 10 or in the transport direction of the printing medium 3, and the nozzle row for printing the background image is disposed on the downstream side. In other words, only the disposition order of each head unit differs in FIGS. 10 to 13, there is no difference in that the plasma actuator 20 is provided in the downstream direction of the reaction liquid discharge nozzle row, and it is needless to say that the same operational effects as those described in the present embodiment are achieved.

Further, in the above-described second embodiment, it is described that the air volume of the airflow generated by the plasma actuator 20 that corresponds to the mist of the reaction liquid that aggregates the background image ink is larger than the airflow generated by the plasma actuator 20 that corresponds to the mist of the reaction liquid that aggregates the main image ink. It is needless to say that similar configurations can also be applied to the printing apparatus 1 of the first embodiment and the printing apparatus 1b of the third embodiment which are described above, and the same operational effects can be achieved.

Further, for example, a configuration in which the printing apparatus 1a according to the second embodiment and the printing apparatus 1b according to the third embodiment which are described above respectively include the head unit 40 and the head units 41a to 41d which are separated from each other has been exemplified. However, the head unit 40 and the head units 41a to 41d may be configured to be integrated with each other. Further, a configuration in which the printing apparatus 1a according to the second embodiment and the printing apparatus 1b according to the third embodiment which are described above respectively include the head unit 40, the head units 41a to 41d, the head unit 44, and the head unit 45 which are separated from each other has been exemplified. However, the head units may be configured to be integrated with each other.

Further, for example, in each of the above-described embodiments, the white ink is exemplified as the background image printing ink. However, the background image printing ink is not limited to the white ink, but may be, for example, metallic ink or may be ink used for printing the background image. In addition, as the main image printing ink, the cyan, magenta, yellow, and black inks have been exemplified. However, the main image printing ink is not limited to the inks, but may be, for example, ink used in printing the main image to be superimposed and printed on the background image.

In addition, each functional unit illustrated in FIG. 7 indicates a functional configuration, and a specific embodiment is not particularly limited. In other words, it is not always necessary to mount hardware that corresponds to each functional unit individually, and it is needless to say that the function of a plurality of functional units is realized by executing a program by one processor. In addition, some of the functions realized by software in each of the above-described embodiments may be realized by hardware, or some of the functions realized by hardware may be realized by software. In addition, specific detailed configurations of the other parts of the printing apparatuses 1, 1a, and 1b can be changed in any manner without departing from the spirit of the present invention.

### REFERENCE SIGNS LIST

1 printing apparatus

1a printing apparatus

1b printing apparatus

3 printing medium

10 carriage

11 ink jet head

14 ink discharge nozzle row

14a reaction liquid discharge nozzle row

14b ink discharge nozzle row

14ba to 14bd ink discharge nozzle row

14c reaction liquid discharge nozzle row

14d reaction liquid discharge nozzle row

14e to 14h ink discharge nozzle row

14i reaction liquid discharge nozzle row

14j ink discharge nozzle row

16 head unit

20 plasma actuator

39 driving voltage generation unit

40 head unit

41a to 41d head unit

44 to 45 head unit

DR1 drum

1. A printing apparatus comprising:
an ink discharge nozzle row for discharging an ink;
a reaction liquid discharge nozzle row for discharging a reaction liquid having properties of aggregating the ink; and
a plasma actuator that generates an airflow with respect to a platen gap.

2. The printing apparatus according to claim 1, wherein the plasma actuator is disposed between the ink discharge nozzle row and the reaction liquid discharge nozzle row.

3. The printing apparatus according to claim 1, further comprising:
an ink jet head that is mounted on a carriage that reciprocates in a direction intersecting with a transport direction of a printing medium and has the ink discharge nozzle row.

4. The printing apparatus according to claim 3, wherein the plasma actuator is disposed side by side with the ink discharge nozzle row in a moving direction of the ink jet head.

5. The printing apparatus according to claim 3, further comprising:
a plurality of the plasma actuators that are disposed to interpose the ink discharge nozzle row therebetween.

6. The printing apparatus according to claim 3, wherein the plasma actuator generates the airflow in a discharge direction in which the ink discharge nozzle row discharges the ink.

7. The printing apparatus according to claim 1, further comprising:
an ink jet head having the ink discharge nozzle row that extends in a direction intersecting with a transport direction of a printing medium.

8. The printing apparatus according to claim 7, wherein the plasma actuator is disposed side by side with the ink discharge nozzle row in the transport direction of the printing medium.

9. The printing apparatus according to claim 7, wherein the plasma actuator generates the airflow in a discharge direction in which the ink discharge nozzle row discharges the ink.

10. The printing apparatus according to claim 9, further comprising:
a rotary drum for transporting the printing medium, wherein
the plasma actuator generates the airflow in a direction opposite to a rotational direction in which the drum rotates.

11. The printing apparatus according to claim 1, wherein
the ink discharge nozzle row includes a first ink discharge nozzle row for discharging a background image printing ink for printing a background image and a second ink discharge nozzle row for discharging a main image printing ink for printing a main image, wherein
the reaction liquid discharge nozzle row includes a first reaction liquid discharge nozzle row for discharging a reaction liquid having properties of aggregating the background image printing ink and a second reaction liquid discharge nozzle row for discharging the reaction liquid having properties of aggregating the main image printing ink, and wherein
the plasma actuator is disposed between the first ink discharge nozzle row and the first reaction liquid discharge nozzle row and between the second ink discharge nozzle row and the second reaction liquid discharge nozzle row.

12. The printing apparatus according to claim 11, wherein the plasma actuator disposed between the first ink discharge nozzle row and the first reaction liquid discharge nozzle row generates the airflow having a larger air volume than that of the airflow generated by the plasma actuator disposed between the second ink discharge nozzle row and the second reaction liquid discharge nozzle row.

13. The printing apparatus according to claim 1, further comprising:
a head unit having a driving voltage generation unit that generates a driving voltage for driving the plasma actuator, and the ink discharge nozzle row.

14. The printing apparatus according to claim 1, further comprising:
a head unit having a driving voltage generation unit that generates a driving voltage for driving the plasma actuator, and the reaction liquid discharge nozzle row.

15. The printing apparatus according to claim 1, wherein a length of the plasma actuator is longer than a length of the reaction liquid discharge nozzle row.

16. The printing apparatus according to claim 1, wherein the length of the plasma actuator is longer than a length of the ink discharge nozzle row.

17. A head unit comprising:
an ink discharge nozzle row for discharging an ink;
a reaction liquid discharge nozzle row for discharging a reaction liquid having properties of aggregating the ink; and
a plasma actuator that generates an airflow with respect to a platen gap.
